(19) United States
(12) Patent Application Publication
(10) Pub. No.: US 2025/0382552 A1
(43) Pub. Date: Dec. 18, 2025

(54) PARTICULATE LAUNDRY SOFTENING WASH ADDITIVE

(71) Applicant: The Procter & Gamble Company, Cincinnati, OH (US)

(72) Inventors: Mark Robert SIVIK, Mason, OH (US); Kristin Rhedrick WILLIAMS, West Chester, OH (US); Carola BARRERA, West Chester, OH (US); Lidiany GONZALEZ, West Chester, OH (US); Jocelyn Michelle MCCULLOUGH, Loveland, OH (US)

(21) Appl. No.: 18/746,385

(22) Filed: Jun. 18, 2024

(51) Int. Cl. C11D 3/00; C11D 3/04; C11D 3/12; C11D 3/20; C11D 3/22; C11D 3/37

(52) U.S. Cl. CPC C11D 3/001; C11D 3/046; C11D 3/122; C11D 3/2079; C11D 3/227; C11D 3/3707; C11D 3/3715; C11D 3/3742

(57) ABSTRACT

A composition including a plurality of particles, the plurality of particles comprising: about 25% to about 89% by weight a water soluble carrier; about 5% to about 45% by weight a first hydrophobic conditioning compound having a weight average molecular weight greater than 1000 Da; and about 0.5% to about 10% by weight a deposition aid; about 5% to about 50% by weight a nonhalide salt; and wherein individual particles of the plurality of particles have a mass from about 1 mg to about 1 g.

### FIELD OF THE INVENTION

Through the wash laundry softening additive.

### BACKGROUND OF THE INVENTION

Consumers continually express interest in products that can simplify the processes they use to launder clothes, help them reduce the amount of time they spend dealing with dirty laundry, and help them achieve high levels of cleanliness and softness for their family's clothing. Cleaning and softening of laundry presently require consumers to dose two products to either different compartments of the washing machine or to dose one product to the washing machine and one product to the dyer.

The process of laundering fabric can be broken up into three basic steps: washing, rinsing, and drying. The washing step typically employs water and detergent composition comprising anionic surfactant, along with other active agents that are compatible with anionic surfactants in the unused product form and in the wash liquor formed during the washing step. After washing, the laundry is rinsed one or more times as part of the rinsing step.

Presently, laundry softening is most often and practically accomplished during the rinsing step with a liquid softening composition that is separate from the detergent composition or during the drying step. To apply liquid softening composition to the laundry in the washing machine, the liquid softening composition is introduced to the laundry during the rinsing step. The liquid softening composition may be automatically introduced into the rinse from a compartment that keeps the liquid softening composition separate from the washing composition. The compartment may be part of the agitator, if present, or another part of the washing machine that can be opened to dispense the liquid softening composition into the drum. This is often referred to as softening through the rinse. Softening through the rinse requires the consumer to dose the detergent composition and the softening composition to different locations of the washing machine, which is inconvenient.

Laundry softening can also be accomplished during the drying step using fabric softening sheets. With either of these approaches to cleaning and softening, cleaning is performed separately from softening.

Consumers find it inconvenient to have to dispense multiple products to different locations, whether the locations are part of the washing machine or the locations are distributed between the washing machine and the dryer. What the consumer would like is to be able to dose the detergent composition and the softening composition to a single location.

Unfortunately, liquid detergent compositions tend to be incompatible with softening compositions. Liquid detergent compositions comprise anionic surfactants to help clean the clothing. Softening compositions typically comprise cationic surfactants to soften the clothing. When combined in a single package, the anionic surfactant and cationic surfactant can combine and form a solid precipitate. This results in a problem with stability of the combination when packaged together in a liquid form or together in a wash liquor and a decrease in cleaning performance as compared to the detergent composition in absence of the softening composition. This incompatibility problem is among the reasons that detergent compositions and fabric softening compositions are dosed and applied separate from one another. Liquid fabric softening compositions packaged separately from detergent compositions may not be preferred by some consumers due to the inconvenience of dosing the composition to the washing machine, perceived messiness, and the texture of the product.

With these limitations in mind, there is a continuing unaddressed need for a solid form through the wash fabric softening composition that can be dispensed by the consumer together with the laundry detergent to providing softening through the wash during the washing step.

### SUMMARY OF THE INVENTION

A composition comprising a plurality of particles, the plurality of particles comprising: about 25% to about 94% by weight a water soluble carrier; about 5% to about 45% by weight a first hydrophobic conditioning compound having a weight average molecular weight greater than 1000 Da; about 5% to about 50% by weight an nonhalide salt; about 0.5% to about 10% by weight a deposition aid selected from the group of: (1) a poly alpha-1,3-glucan ether compound having a weight average molecular weight of from 90000 Da to 350000 Da, and a degree of cationic substitution of from 0.03 to 1.0; (2) a poly alpha-1,6-glucan ether compound comprising a poly alpha-1,6-glucan substituted with at least one positively charged organic group, wherein the poly alpha-1,6-glucan comprises a backbone of glucose monomer units wherein at least 65% of the glucose monomer units are linked via alpha-1,6-glycosidic linkages, wherein the poly alpha-1,6-glucan ether compound has a degree of substitution of about 0.001 to about 3.0, and wherein the poly alpha-1,6-glucan ether compound is characterized by: a) a weight average molecular weight of from about 80000 to about 500000 Da, and/or b) having been derived from a poly alpha-1,6-glucan having a weight average molecular weight of from about 50000 Da to about 450000 Da, determined prior to substitution with the least one positively charged organic group; (3) a poly alpha-1,3-glucan, alpha-1,6-glucan ether compound having a weight average molecular weight of from 90000 Da to 350000 Da, and a degree of cationic substitution of from 0.03-1.0 optionally from 0.05-0.09, optionally 0.15 to 0.8, optionally 0.07 to 0.11; and (4) combinations thereof; and wherein individual particles of the plurality of particles have a mass from about 1 mg to about 1 g.

### DETAILED DESCRIPTION OF THE INVENTION

The composition described herein can provide for a through the wash fabric softening composition that is convenient for the consumer to dose to the washing machine. The through the wash fabric softening composition can be provided in a composition comprising a plurality of particles. The particles can be provided in a package that is separate from the package of detergent composition. Having the softening composition particles in a package separate from the package of detergent composition can be beneficial since it allows the consumer to select the amount of softening composition independent of the amount of detergent composition used. This can give the consumer the opportunity to customize the amount of softening composition used and thereby the amount of softening benefit they achieve, which is a highly valuable consumer benefit.

Particulate products, especially particulates that are not dusty, are preferred by many consumers. Particulate products can be easily dosed by consumers from a package directly into the washing machine or into a dosing compartment on the washing machine. Or the consumer can dose from the package into a dosing cup that optionally provides one or more dosing indicia and then dose the particulates into a dosing compartment on the washing machine or directly to the drum. For products in which a dosing cup is employed, particulate products tend to be less messy than liquid products.

The plurality of particles of the fabric softening composition can comprise a water soluble carrier and a first hydrophobic conditioning compound having a weight average molecular weight greater than 1000 Da (Da being the abbreviation for Daltons). Optionally, they may comprise a cationic polysaccharide. The carrier carries the first hydrophobic condition compound to the washing machine. The particles are dissolved into the wash liquor. The first hydrophobic conditioning compound is deposited from the wash liquor onto the fibers of the fabric.

### Water Soluble Carrier

The plurality of particles can comprise a water soluble carrier. The plurality of particles can comprise from about 25% to about 94%, optionally from about 25% to about 89%, optionally from about 25% to about 81%, optionally from about 30% to about 90%, optionally from about 35% to about 88%, optionally from about 40% to about 88%, optionally from about 45% to about 85%, optionally combinations thereof and any whole percentages or ranges of whole percentages within any of the aforementioned ranges, by weight of the plurality of particles. The water soluble carrier acts to carry the fabric care benefit agents to the wash liquor. Upon dissolution of the water soluble carrier, the first hydrophobic conditioning compound and any additional substances constituting the particles are dispersed into the wash liquor.

Water soluble means that the material or particle is soluble or dispersible in water, and optionally has a water-solubility of at least 50%, optionally at least 75% or even at least 95%, as measured by the method set out hereafter using a glass-filter with a maximum pore size of 20 microns: 50 grams±0.1 gram of the carrier is added in a pre-weighed 400 mL beaker and 245 mL±1 mL of distilled water is added. This is stirred vigorously on a magnetic stirrer set at 600 rpm, for 30 minutes. Then, the mixture is filtered through a sintered-glass filter with a pore size as defined above (max. 20 micron). The steps are performed at a temperature of 23° C.±1.0° C. and a relative humidity of 50%+2%. The water is dried off from the collected filtrate by any conventional method, and the weight of the remaining material is determined (which is the dissolved or dispersed fraction). Then, the percentage solubility or dispersibility can be calculated.

The water soluble carrier can be or comprise a material selected from the group of water soluble carbohydrates with less than ten saccharide units including dextrose, fructose, galactose, isoglucose, glucose, sucrose, raffinose, isomalt, xylitol, candy sugar, coarse sugar, corn syrup solids, sucrose, and combinations thereof.

The water soluble carrier can be selected from the group of polysaccharide and modified polysaccharide that are not cationic with more than ten saccharide units including maltodextrin, starch, corn starch, wheat starch, rice starch, potato starch, tapioca starch, carboxymethyl cellulose, cellulose, alkyl cellulosics such as methyl cellulose, ethyl cellulose and propyl cellulose; cellulose ethers; cellulose esters; nonionic or anionic cellulose amides, polysaccharides including starch, modified starch that is not cationic; gelatin; alginates; xyloglucans, other hemicellulosic polysaccharides including xylan, glucuronoxylan, arabinoxylan, mannan, glucomannan and galactoglucomannan; and natural gums such as pectin, xanthan, and carrageenan, locus bean, arabic, tragacanth, alkylhydroxy cellulosics such as methylcellulose, carboxymethylcellulose sodium, modified carboxy-methylcellulose that is not cationic, dextrin, ethylcellulose, propylcellulose, hydroxyethyl cellulose, hydroxypropyl methylcellulose, maltodextrin; hydroxypropyl methyl cellulose (HPMC); cellulose, alkyl cellulosics, methyl cellulose, ethyl cellulose, propyl cellulose, cellulose ethers, cellulose esters, polysaccharides, alkylhydroxy cellulosics, methylcellulose, carboxymethylcellulose sodium, dextran, ethylcellulose, hydroxyethyl cellulose, hydroxypropyl methylcellulose, hydroxypropyl methyl cellulose, maltodextrin and combinations thereof.

The water soluble carrier can be selected from the group of clay, silicate, citric acid, water soluble silicate, water soluble urea, clay, water insoluble silicate, zeolites silicates, zeolites, polyethylene glycol, and combinations thereof.

The water soluble carrier can be selected from the group of polyethylene glycol, polypropylene glycol polyoxoalkylene, polyethylene glycol fatty acid ester, polyethylene glycol ether, and mixtures thereof.

The water soluble carrier can be a water soluble polymer. The water soluble polymer can be selected from the group of C8-C22 alkyl polyalkoxylate comprising more than about 40 alkoxylate units, ethoxylated nonionic surfactant having a degree of ethoxylation greater than about 30, polyalkylene glycol having a weight average molecular weight from about 2000 to about 15000, and combinations thereof.

The water soluble polymer can be a block copolymer having Formulae (I), (II), (III) or (IV), R¹O-(EO)x-(PO)y-R² (I), R¹O—(PO)x-(EO)y-R² (II), R¹O-(EO)o-(PO)p-(EO)q-R² (III), R¹O—(PO)o-(EO)p-(PO)q-R² (IV), or a combination thereof; wherein EO is a —CH₂CH₂O— group, and PO is a —CH(CH₃)CH₂O— group; R¹ and R² independently is H or a C1-C22 alkyl group; x, y, o, p, and q independently is 1-100; provided that the sum of x and y is greater than 35, and the sum of o, p and q is greater than 35; wherein the block copolymer has a molecular weight ranging from about 3000 Da to about 15000 Da.

The water soluble polymer can be a block copolymer or block copolymers, for example a block copolymer based on ethylene oxide and propylene oxide selected from the group of PLURONIC-F38, PLURONIC-F68, PLURONIC-F77, PLURONIC-F87, PLURONIC-F88, and combinations thereof. PLURONIC materials are available from BASF.

The water soluble polymer can be selected from the group of polyvinyl alcohols (PVA), modified PVAs; polyvinyl pyrrolidone; PVA copolymers such as PVA/polyvinyl pyrrolidone and PVA/polyvinyl amine; partially hydrolyzed polyvinyl acetate; polyalkylene oxides such as polyethylene oxide; polyethylene glycols; acrylamide; acrylic acid; polyvinyl acetates; polycarboxylic acids; polyaminoacids or peptides; polyamides; polyacrylamide; copolymers of maleic/acrylic acids; In one embodiment the polymer comprises polyacrylates, especially sulfonated polyacrylates and water-soluble acrylate copolymers; and, polymethacrylates. In yet another embodiment the water soluble polymer can be selected from the group of PVA; PVA copolymers; and mixtures thereof.

The water soluble polymer can be selected from the group of polyvinyl alcohol, modified polyvinyl alcohol, polyvinyl pyrrolidone, polyvinyl alcohol/polyvinyl pyrrolidone, polyvinyl alcohol/polyvinyl amine, partially hydrolyzed polyvinyl acetate, polyalkylene oxide, polyethylene glycol, acrylamide, acrylic acid, polyvinyl acetates, polycarboxylic acids and salts, polyaminoacids or peptides, polyamides, polyacrylamide, copolymers of maleic/acrylic acids, polymethacrylates, polyvinyl alcohol copolymers, and mixtures thereof.

The water soluble carrier can be an organic material. Organic water soluble carriers may provide a benefit of being readily soluble in water.

The water soluble carrier can be selected from the group of polyethylene glycol, polypropylene glycol polyoxoalkylene, polyethylene glycol fatty acid ester, polyethylene glycol ether, nonionic starch, and mixtures thereof.

The water soluble carrier can be polyethylene glycol (PEG). PEG can be a convenient material to employ to make particles because it can be sufficiently water soluble to dissolve during a wash cycle when the particles have the range of mass disclosed herein. Further, PEG can be easily processed as melt. The onset of melt temperature of PEG can vary as a function of molecular weight of the PEG.

The plurality of particles can comprise about 20% to about 94% by weight PEG having a weight average molecular weight from about 2000 Da to about 15000 Da. PEG has a relatively low cost, may be formed into many different shapes and sizes, and dissolves well in water. PEG comes in various weight average molecular weights. A suitable weight average molecular weight range of PEG includes from about 2000 Da to about 13000 Da, alternatively from about 4000 Da to about 13000 Da, alternatively from about 4000 Da to about 12000 Da, alternatively from about 4000 Da to about 11000 Da, alternatively from about 5000 Da to about 11000 Da, alternatively from about 6000 Da to about 10000 Da, alternatively from about 7000 Da to about 9000 Da, alternatively combinations thereof. PEG is available from BASF, for example PLURIOL E 8000, or other PLURIOL product. The water soluble carrier can be a mixture of two or more polyethylene glycol compositions, one having a first weight average molecular weight (e.g. 9000 Da) and the other having a second weight average molecular weight (e.g. 4000 Da), the second weight average molecular weight differing from the first weight average molecular weight.

The plurality of particles can comprise about 25% to about 94% by weight of the individual particles of PEG. Optionally, the plurality of particles can comprise about 25% to about 89% by weight of the individual particles of PEG. Optionally, the plurality of particles can comprise from about 30% to about 92%, optionally from about 35% to about 90%, optionally from about 50% to about 80%, optionally combinations thereof and any whole percentages or ranges of whole percentages within any of the aforementioned ranges, of PEG by weight of the plurality of particles.

The water soluble carrier can comprise a material selected from the group of: a polyalkylene polymer of formula H—(C₂H₄O)ₓ—(CH(CH₃)CH₂O)_{y}—(C₂H₄O)_{z}—OH wherein x is from about 50 to about 300, y is from about 20 to about 100, and z is from about 10 to about 200; a polyethylene glycol fatty acid ester of formula (C₂H₄O)_{q}—C(O)O—(CH₂)ᵣ—CH₃ wherein q is from about 20 to about 200 and r is from about 10 to about 30; a polyethylene glycol fatty alcohol ether of formula HO—(C₂H₄O)ₛ—(CH₂)ₜ)—CH₃ wherein s is from about 30 to about 250 and t is from about 10 to about 30; and mixtures thereof. The polyalkylene polymer of formula H—(C₂H₄O)ₓ—(CH(CH₃)CH₂O)_{y}—(C₂H₄O)_{z}—OH wherein x is from about 50 to about 300, y is from about 20 to about 100, and z is from about 10 to about 200, can be a block copolymer or random copolymer.

The water soluble carrier can comprise: polyethylene glycol; a polyalkylene polymer of formula H—(C₂H₄O)ₓ—(CH(CH₃)CH₂O)_{y}—(C₂H₄O)_{z}—OH wherein x is from about 50 to about 300; y is from about 20 to about 100, and z is from about 10 to about 200; a polyethylene glycol fatty acid ester of formula (C₂H₄O)_{q}—C(O)O—(CH₂)ᵣ—CH₃ wherein q is from about 20 to about 200 and r is from about 10 to about 30; and a polyethylene glycol fatty alcohol ether of formula HO—(C₂H₄O)ₛ—(CH₂)ₜ)—CH₃ wherein s is from about 30 to about 250 and t is from about 10 to about 30.

The water soluble carrier can comprise from about 25% to about 89% by weight of the plurality of particles or by weight of the individual particles of polyalkylene polymer of formula H—(C₂H₄O)ₓ—(CH(CH₃)CH₂O)_{y}—(C₂H₄O)_{z}—OH wherein x is from about 50 to about 300; y is from about 20 to about 100, and z is from about 10 to about 200.

The water soluble carrier can comprise from about 1% to about 20% by weight of the plurality of particles or by weight of the individual particles polyethylene glycol fatty acid ester of formula (C₂H₄O)_{q}—C(O)O—(CH₂)ᵣ—CH₃ wherein q is from about 20 to about 200 and r is from about 10 to about 30.

The water soluble carrier can comprise from about 1% to about 10% by weight of the plurality of particles or by weight of the individual particles of polyethylene glycol fatty alcohol ether of formula HO—(C₂H₄O)ₛ—(CH₂)ₜ)—CH₃ wherein s is from about 30 to about 250 and t is from about 10 to about 30.

The water soluble carrier can comprise plasticizer polyol (from 0% to 3% by weight of the plurality of particles or by weight of the individual particles), wherein the plasticizer polymer is optionally a liquid at 20 C and 1 atmosphere of pressure; water (from 1% to 20%, or 1% to 12%, or 6% to 8%, by weight of the plurality of particles or by weight of the individual particles); sugar alcohol polyol selected from the group of erythritol, xylitol, mannitol, isomalt, maltitol, lactitol, trehalose, lactose, tagatose, sucralose, and mixtures thereof (from 45% to 80%, or 50% to 70%, or 50% to 60%, by weight of the plurality of particles or by weight of the individual particles); wherein the plurality of particles or individual particles further comprise: (a) modified starch that is not cationic having a dextrose equivalent from 15 to 20 and the sugar alcohol polyol and the modified starch are present at a weight ratio of the sugar alcohol polyol to the modified starch from 2:1 to 16:1, or from 2:1 to 10:1, or from 2:1 to 3:1; or (b) modified starch that is not cationic having a dextrose equivalent from 4 to less than 15 and the sugar alcohol polyol and the modified starch are present at a weight ratio of the sugar alcohol polyol to the modified starch from 1.5:1 to 16:1, or from 1.5:1 to 10:1, or from 1.5:1 to 4. The modified starch that is not cationic can have a dextrose equivalent from 15 to 20 and the sugar alcohol polyol and the modified starch can be present at a ratio from 2:1 to 16:1, or from 2:1 to 10:1, or from 2:1 to 3:1. The modified starch can have a dextrose equivalent from 4 to less than 15 and the sugar alcohol polyol and the modified starch can be present at a weight ratio of the sugar alcohol polyol to the modified starch from 1.5:1 to 16:1, or from 1.5:1 to 10:1, or from 1.5:1 to 4:1. The modified starch can have a dextrose equivalent from 4 to 12. The modified starch can be maltodextrin. The sugar alcohol polyol can be mannitol. The plasticizer polyol can be selected from the group of glycerin, dipropylene glycol, propylene glycol, and mixtures thereof.

The water soluble carrier can be selected from the group of a polyalkylene polymer of formula H—(C₂H₄O)ₓ—(CH(CH₃)CH₂O)_{y}—(C₂H₄O)_{z}—OH wherein x is from 50 to 300, y is from 20 to 100, and z is from 10 to 200; a polyethylene glycol fatty acid ester of formula (C₂H₄O)_{q}—C(O)O—(CH₂)ᵣ—CH₃ wherein q is from 20 to 200 and r is from 10 to 30; a polyethylene glycol fatty alcohol ether of formula HO—(C₂H₄O)ₛ—(CH₂)ₜ)—CH₃ wherein s is from 30 to 250 and t is from 10 to 30; C8-C22 alkyl polyalkoxylate comprising more than 40 alkoxylate units; polyethylene glycol having a weight average molecular weight from 2000 to 15000; EO/PO/EO block copolymer; PO/EO/PO block copolymer; EO/PO block copolymer; PO/EO block copolymer; polypropylene glycol; ethoxylated nonionic surfactant having a degree of ethoxylation greater than 30; polyvinyl alcohol; polyalkylene glycol having a weight average molecular weight from 2000 to 15000; and mixtures thereof.

### Adjunct

The plurality of particles can comprise additional adjunct ingredients. These additional adjunct ingredients can act as processing aids and modify particle properties such as solubility and rate of dissolution, dissolution stability, resistance to moisture pickup from humidity in storage, stretchability, feel, brittleness, and texture of the substrate, appearance and shine, and ease and speed of processing, casting, extruding, or drying the substrate, mechanical handling of the substrate, and storage of the substrate. The adjunct can be selected from the group of fatty acid, fatty alcohol, mono or diester fatty triglycerides, glyceryl diester of hydrogenated tallow, glyceryl monoester of hydrogenated tallow, glycerol, and combinations thereof. Additional adjunct ingredients can include colorants, dyes, solvents, germ killing materials, antioxidants, anti-mite materials, dye transfer inhibitors, and combinations thereof. Optionally, the colorants include at least one dye selected from those typically used in laundry detergent. Examples of suitable dyes include, but are not limited to, LIQUITINT BLUE BL, LIQUITINT PINK AM, AQUA AS CYAN 15, and VIOLET FL, available from Milliken Chemical.

### Deposition Aid

The particles can comprise a deposition aid. The deposition aid that can help to deposit onto the fabric the first hydrophobic conditioning compound, the optionally second hydrophobic conditioning compound, and possibly some other optional benefit agents that are contained in the particles. The deposition aid can be dispersed in the water soluble carrier. The deposition aid can be uniformly dispersed or randomly dispersed in the water soluble carrier.

The particles can comprise about 0.5% to about 10% by weight a deposition aid selected from the group of: poly alpha-1,3-glucan ether compound; poly alpha-1,6-glucan ether compound; poly alpha-1,3, alpha-1,6-glucan ether compound; and combinations thereof. Optionally, the particles can comprise about 0.5% to about 5%, optionally about 1% to about 5%, optionally about 2% to about 4%, or even about 3%, by weight a deposition aid selected from the group of: poly alpha-1,3-glucan ether compound; poly alpha-1,6-glucan ether compound; poly alpha-1,3, alpha-1,6-glucan ether compound; and combinations thereof. Without being bound by theory, it is thought that the cleaning performance of laundry detergent in the wash decreases with increasing levels of poly alpha-1,3-glucan ether compound, poly alpha-1,6-glucan ether compound and or poly alpha-1,3, alpha-1,6-glucan ether compound in the particles and acceptable cleaning performance of the detergent can be maintained within the aforesaid ranges.

The particles can comprise about 0.5% to about 10% by weight a deposition aid selected from the group of: (1) a poly alpha-1,3-glucan ether compound having a weight average molecular weight of from 90000 Da to 350000 Da, and a degree of cationic substitution of from 0.03 to 1.0 optionally from 0.05 to 0.09, optionally 0.15 to 0.8, optionally 0.07 to 0.11; (2) a poly alpha-1,6-glucan ether compound comprising a poly alpha-1,6-glucan substituted with at least one positively charged organic group, wherein the poly alpha-1,6-glucan comprises a backbone of glucose monomer units wherein at least 65% of the glucose monomer units are linked via alpha-1,6-glycosidic linkages, wherein the poly alpha-1,6-glucan ether compound has a degree of substitution of about 0.001 to about 3.0, and wherein the poly alpha-1,6-glucan ether compound is characterized by: a) a weight average molecular weight of from about 80000 Da to about 500000 Da, and/or b) having been derived from a poly alpha-1,6-glucan having a weight average molecular weight of from about 50000 Da to about 450000 Da, determined prior to substitution with the least one positively charged organic group; (3) a poly alpha-1,3-glucan alpha-1,6-glucan ether compound having a weight average molecular weight of from 90000 Da to 350000 Da, and a degree of cationic substitution of from 0.03-1.0 optionally from 0.05-0.09, optionally 0.15 to 0.8 optionally 0.07 to 0.11; and (4) combinations thereof.

Suitable poly alpha-1,3-glucan ether compounds that can be used in the plurality of particles described herein are described in United States Patent Publication 2023/0043452 A1. The poly alpha-1,3-glucan ether compound can have a weight average molecular weight of from 90000 Da to 350000 Da and a degree of cationic substitution of from 0.03 to 0.8. The plurality of particles can comprise about 0.5% to about 10% by weight a poly alpha-1,3-glucan ether compound having a weight average molecular weight of from 90000 Da to 350000 Da and a degree of cationic substitution of from 0.03 to 0.8.

Optionally the poly alpha-1,3-glucan ether compound can have a weight average molecular weight of from 90000 to 300000 Da. Optionally, the poly alpha-1,3-glucan ether compound can have a weight average molecular weight of from 100000 Da to 175000 Da. Optionally, the poly alpha-1,3-glucan ether compound can have a degree of cationic substitution of from 0.03 to 0.8. The poly alpha-1,3-glucan ether compound can comprise a backbone that is substantially linear, having fewer than 10% branch points as a percent of glycosidic linkages in the backbone.

The poly alpha-1,3-glucan ether compound can comprise from 425 to 1200 structural units having the following structure:

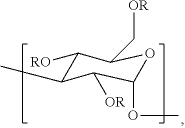

wherein each R is independently an H or a positively charged organic group.

The poly alpha-1,3-glucan ether compound is substituted with a positively charged organic group that comprises a substituted ammonium group. Optionally, the substituted ammonium group can be a trimethylammonium group.

The poly alpha-1,3-glucan ether compound can be substituted with at least one positively charged organic group that comprises an alkyl group or hydroxy alkyl group. Optionally, the at least one positively charged organic group can comprise a quaternary ammonium hydroxypropyl group.

Optionally, the poly alpha-1,3-glucan ether compound can be provided as a premix, wherein the premix comprises from 5% to 20%, by weight of the premix, of the poly alpha-1,3-glucan ether compound. Optionally, the premix can further comprise water.

Suitable poly alpha-1,6-glucan ether compounds that can be used in the plurality of particles described herein are described in United States Patent Publication 2021/0395649 A1 and U.S. patent application Ser. No. 17/350,086. The plurality of particles can comprise about 0.5% to about 10% by weight a poly alpha-1,6-glucan ether compound comprising a poly alpha-1,6-glucan substituted with at least one positively charged organic group. The poly alpha-1,6-glucan can comprise a backbone of glucose monomer units wherein at least 65% of the glucose monomer units are linked via alpha-1,6-glycosidic linkages. The poly alpha-1,6-glucan ether compound can be characterized by: a) a weight average molecular weight of from about 80000 Da to about 500000 Da, and/or b) having been derived from a poly alpha-1,6-glucan having a weight average molecular weight of from about 50000 Da to about 450000 Da, determined prior to substitution with the least one positively charged organic group. The poly alpha-1,6-glucan ether compound can be further characterized by a degree of substitution of about 0.001 to about 3.0. Optionally, the poly alpha-1,6-glucan ether compound can be characterized by a weight average molecular weight of from about 80000 Da to about 300000 Da. Optionally, the poly alpha-1,6-glucan ether compound can be characterized by having been derived from a poly alpha-1,6-glucan having a weight average molecular weight of from about 50000 Da to about 350000 Da, determined prior to substitution with the least one positively charged organic group. Optionally, the poly alpha-1,6-glucan can comprise a backbone of glucose monomer units wherein at least 70% of the glucose monomer units are linked via alpha-1,6-glycosidic linkages. Optionally, the poly alpha-1,6-glucan ether compound can be characterized by a weight average molecular weight of from about 150000 Da to about 225000 Da, a degree of substitution of from about 0.05 to about 0.5, and wherein from about 5% to about 20% of the backbone glucose monomer units have branches via alpha-1,2 and/or alpha-1,3-glycosidic linkages.

Optionally, at least 3% of the backbone glucose monomer units can have branches via alpha-1,2 and/or alpha-1,3-glycosidic linkages. Further optionally, the positively charged organic group can comprise a substituted ammonium group. If present, the quaternary ammonium group can comprise at least one C₁ to C₁₈ alkyl group. Optionally, the quaternary ammonium group can comprise a trimethylammonium group.

The poly alpha-1,6-glucan ether compound comprising a poly alpha-1,6-glucan can be substituted with at least one positively, charged organic group, the positively charged organic group comprising a quaternary ammonium hydroxyalkyl group. Optionally, the quaternary ammonium hydroxyalkyl group can comprise a trimethylammonium hydroxyalkyl group.

### Hydrophobic Conditioning Compounds

The plurality of particles can comprise a first hydrophobic conditioning compound and an optional second hydrophobic conditioning compound. The first hydrophobic conditioning compound and said second hydrophobic conditioning compound together can constitute from about 6% to about 45% by weight of said composition. The first hydrophobic conditioning compound and said second hydrophobic conditioning compound together can constitute from about 5% to about 45% by weight of said composition. The first hydrophobic conditioning compound can have a weight average molecular weight greater than 1000 Da. The optional second hydrophobic conditioning compound can have a weight average molecular weight greater than 1000 Da. The plurality of particles can comprise from about 5% to about 45%, optionally from about 8% to about 15%, optionally from about 5% to about 30%, optionally from about 5% to about 20%, optionally from about 8% to about 25%, by weight the first hydrophobic conditioning compound.

The plurality of particles can comprise from about 5% to about 45%, optionally from about 8% to about 15%, optionally from about 5% to about 30%, optionally from about 5% to about 20%, optionally from about 8% to about 25%, by weight the second hydrophobic conditioning compound.

The first hydrophobic conditioning compound can be dispersed in the water soluble carrier. The second hydrophobic conditioning compound can be dispersed in the water soluble carrier. Both the first hydrophobic conditioning compound and second hydrophobic conditioning compound can be dispersed in the water soluble carrier. The first hydrophobic conditioning compound and option second hydrophobic conditioning compound can be uniformly dispersed or randomly dispersed in the water soluble carrier.
A) The first hydrophobic conditioning compound and or second hydrophobic conditioning compound can be a branched polyester selected from the group of:
(a) a branched polyester having Formula 1

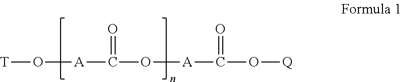

wherein:
each A is independently a branched hydrocarbon chain comprising 4 to 100 carbon atoms;
Q is selected from an alkyl chain comprising 1 to 30 carbon atoms and a hydrogen atom;
T is a hydrogen atom or a —C(O)—R wherein each R is an alkyl chain comprising 1 to 30 carbon atoms; and
n is an integer from 1 to about 100;
(b) a branched polyester having Formula 2

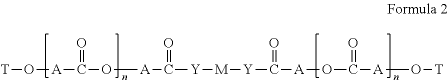

wherein:
each n is independently an integer from 1 to about 100;
each A is independently a branched hydrocarbon chain comprising 4 to 100 carbon atoms;
each T is independently a hydrogen atom or a —C(O)—R wherein each R is an alkyl chain comprising 1 to 30 carbon atoms;
each Y is independently a linking group selected from the group of oxygen and NR2, wherein each R2 is independently selected from the group of hydrogen, or a C1-C8 alkyl; and
M is a polyalkylene glycol group;
(c) a branched polyester having Formula 3

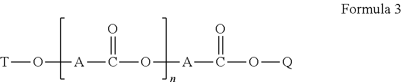

wherein:
the index n is an integer from 1 to about 100, optionally the index n is an integer from 4 to about 40, optionally the index n is an integer from 5 to about 20;
T is a hydrogen or —C(O)—R1 where in R1 is an alkyl chain comprising from 7 to 21 carbon atoms, optionally R1 is an alkyl chain comprising from 11 to 17 carbon atoms;
each A is independently a branched hydrocarbon chain comprising from 4 to 40 carbon atoms, optionally from 12 to 20 carbon atoms, optionally 17 carbon atoms;
Y is selected from the group of oxygen and NR2, wherein each R2 is independently selected from the group of hydrogen, or a C1-C8 alkyl, optionally, Y is selected from —O— and

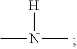

Q is selected from the group of:
i) —B
ii) —Z—X—Z—W, and
iii) —V—U—Z—X—Z—W
optionally, Q is selected from the group of:
i) —B, and
ii) —Z—X—Z—W
wherein
B is a substituted C1-C24 alkyl group, optionally the substituents are selected from the group of hydroxyl, primary amine, secondary amine, tertiary amine, quaternary ammonium group and mixtures thereof, more optionally B comprises from 1 to 4 substituents selected from the group of hydroxyl, primary amine, secondary amine, tertiary amine, quaternary ammonium group and mixtures thereof; each Z is independently a substituted or unsubstituted divalent C2-C40 alkylene radical, optionally each Z is independently a substituted or unsubstituted divalent C2-C20 alkylene, most optionally each Z is independently selected from the group of:

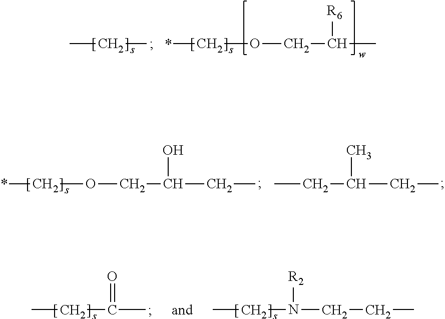

wherein * signifies a bond of the Z moiety to a X moiety of the branched polyester;
each R2 is independently selected from the group of hydrogen or a C1-C8 alkyl;
each R6 is independently selected from the group of hydrogen, or a C1-C3 alkyl, optionally a hydrogen or methyl;
each s is independently an integer from about 2 to about 8, optionally each s is independently an integer from about 2 to about 4;
each w is independently an integer from 1 to about 20, optionally each w is independently an integer from 1 to about 10, more optionally each w is independently an integer from 1 to about 8;
X is polysiloxane moiety, optionally X has the formula

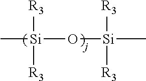

wherein each R3 is independently selected from the group of H; C1-C32 alkyl; C1-C32 substituted alkyl, C5-C32 or C6-C32 aryl, C5-C32 or C6-C32 substituted aryl; C6-C32 alkylaryl, C6-C32 substituted alkylaryl, and C1-C32 alkoxy moieties, optionally each R3 is independently selected from H; C1-C16 alkyl; C1-C16 substituted alkyl substituted with amino, hydroxyl, carboxyl or polyether moieties, optionally, each R3 is independently selected from H, methyl and methoxy groups; and
j is an integer from 5 to about 1000, optionally j is an integer from about 10 to 500, optionally j is an integer from about 20 to 300;
W is selected from the group of —OR4,

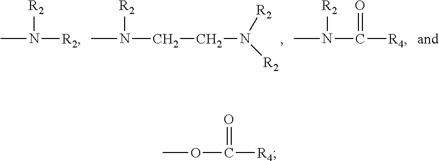

each R2 is independently selected from the group of hydrogen or a C1-C8 alkyl;
R4 is selected from a hydrogen atom, a C1-C24 alkyl group or a substituted C1-C24 alkyl group, optionally the substituents being from 1 to 4 functional moieties selected from the group of hydroxyl, primary amine, secondary amine, tertiary amine, quaternary ammonium group and mixtures thereof, C5-C32 or C6-C32 aryl, C5-C32 or C6-C32 substituted aryl; C6-C32 alkylaryl, and C6-C32 substituted alkylaryl, optionally R4 is selected from a hydrogen atom, a C1-C24 alkyl group or a substituted C1-C24 alkyl group, optionally the substituents being from 1 to 4 functional moieties selected from the group of hydroxyl, primary amine, secondary amine, tertiary amine, quaternary ammonium group and mixtures thereof;
V is a C1-C24 divalent alkylene radical or a substituted C1-C24 divalent alkylene, optionally the substituents being from 1 to 4 functional moieties selected from the group of hydroxyl, primary amine, secondary amine, tertiary amine, quaternary ammonium group and mixtures thereof;
U is —C(O)O— or —C(O)NH—; and/or
(d) a branched polyester having Formula 4

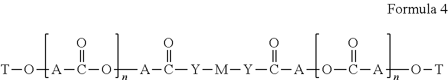

wherein:
   each index n is independently an integer from 1 to about 100;
   T is a hydrogen atom or —C(O)—R₁ where in R₁ is an alkyl chain comprising from 7 to 21 carbon atoms, optionally from 11 to 17 carbon atoms;
   each A is independently a branched hydrocarbon chain comprising from 4 to 40 carbon atoms, optionally from 12 to 20 carbon atoms, optionally 17 carbon atoms;
   each Y is independently selected from the group of oxygen and NR₂, wherein each R₂ is independently selected from the group of hydrogen or a C₁-C₈ alkyl;
   M is selected from the group of:
      i) a C₁-C₂₄ divalent linear or branched alkylene radical, optionally the C₁-C₂₄ divalent linear or branched alkylene radical comprises one to four functional groups selected from the group of hydroxyl, primary amine, secondary amine, tertiary amine, quaternary ammonium group and mixtures thereof; optionally the C₁-C₂₄ divalent linear or branched alkylene radical has the formula:

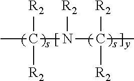

wherein each R₂ is independently selected from the group of hydrogen or a C₁-C₈ alkyl; each s is independently an integer from about 2 to about 10, optionally each s is independently an integer from about 2 to about 8, optionally each s is independently an integer from about 2 to about 4; y is an integer from about 1 to about 20;
ii) —Z—X—Z, and
iii) -(D-UZ—X—Z—U)ₘ-D-
wherein:
   m is an integer from 1 to about 10;
   each Z is independently a substituted or unsubstituted divalent C₂-C₄o alkylene radical, optionally each Z is independently a substituted or unsubstituted divalent C₂-C₂₀ alkylene, optionally each Z is independently selected from the group of:

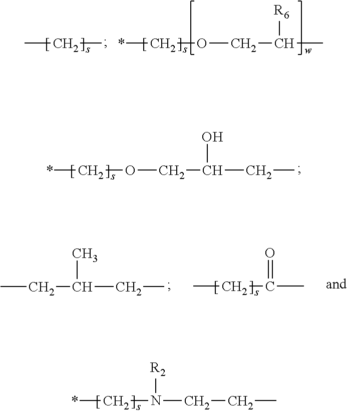

wherein * signifies a bond of the Z moiety to a X moiety of the branched polyester;
each R₂ is independently selected from the group of hydrogen or a C₁-C₈ alkyl;
each R₆ is independently selected from the group of hydrogen, or a C₁-C₃ alkyl, optionally a hydrogen or methyl;
each s is independently an integer from about 2 to about 8, optionally each s is independently an integer from about 2 to about 4;
each w is independently an integer from 1 to about 20, optionally each w is independently an integer from 1 to about 10, optionally each w is independently an integer from 1 to about 8;
X is polysiloxane moiety, optionally X has the formula:

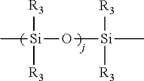

wherein each R₃ is independently selected from the group of H; C₁-C₃₂ alkyl; C₁-C₃₂ substituted alkyl, C₅-C₃₂ or C₆-C₃₂ aryl, C₅-C₃₂ or C₆-C₃₂ substituted aryl; C₆-C₃₂ alkylaryl, C₆-C₃₂ substituted alkylaryl, and C₁-C₃₂ alkoxy moieties, optionally each R₃ is independently selected from H; C₁-C₁₆ alkyl; C₁-C₁₆ substituted alkyl substituted with amino, hydroxyl, carboxyl or polyether moieties, optionally, each R₃ is independently selected from H, methyl and methoxy groups; and
j is an integer from 5 to about 1000, optionally j is an integer from about 20 to 500;
U is —C(O)O— or —C(O)NH—; and
each D is independently a C₁-C₂₄ divalent linear or branched alkylene radical, the alkylene radical optionally the C₁-C₂₄ divalent linear or branched alkylene radical comprises one to four functional groups selected from the group of hydroxyl, primary amine, secondary amine, tertiary amine, quaternary ammonium group and mixtures thereof; optionally the C₁-C₂₄ divalent linear or branched alkylene radical has the formula:

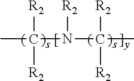

wherein each R₂ is independently selected from the group of hydrogen or a C₁-C₈ alkyl; each s is independently an integer from about 2 to about 10, optionally each s is independently an integer from about 2 to about 8, optionally each s is independently an integer from about 2 to about 4; y is an integer from about 1 to about 20;
(e) and mixtures thereof;

The polyhydroxystearic acid of Formula 1 can be HYPERMER LP1, available from Croda Inc & Sederma Inc., Edison, New Jersey, United States of America. They polyhydroxystearic acid of Formula 1 can be SALACOS HS-4C, available from Nisshin Oillio Group, Ltd., Tokyo, Japan. They polyhydroxystearic acids of Formula 2 can be HYPERMER B261, HYPERMER B210, and HYPERMER B246, available from Croda Inc & Sederma Inc., Edison, New Jersey, United States of America.
B) The first hydrophobic conditioning compound and or second hydrophobic conditioning compound can be a branched polyester selected from the group of:
(a) the branched polyester of the Formula 1

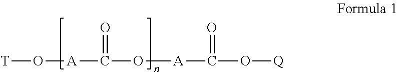

wherein:
each A is independently a branched hydrocarbon chain comprising from 4 to 40 carbon atoms, optionally from 12 to 20 carbon atoms, optionally 17 carbon atoms
Q is selected from an alkyl chain comprising 1 to 30 carbon atoms and a hydrogen atom, optionally Q is a hydrogen atom;
T is a hydrogen atom or a —C(O)—R wherein each R is an alkyl chain comprising from 7 to 21 carbon atoms, optionally from 11 to 17 carbon atoms; and
n is an integer from 4 to 40, optionally n is an integer from 5 to 20;
(b) the branched polyester of the Formula 2

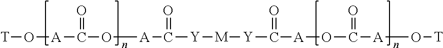

wherein:
n is an integer from 4 to 40, optionally n is an integer from 5 to 20
each A is independently a branched hydrocarbon chain comprising from 4 to 40 carbon atoms, optionally from 12 to 20 carbon atoms, optionally 17 carbon atoms
each T is independently a hydrogen atom or a —C(O)—R wherein each R is an alkyl chain comprising from 7 to 21 carbon atoms, optionally from 11 to 17 carbon atoms;
each Y is independently a linking group selected from the group of oxygen and NR2, wherein each R2 is independently selected from the group consisting of hydrogen, or a C1-C8 alkyl, optionally each R2 is hydrogen;
M is a polyalkylene glycol group, optionally M has the structure

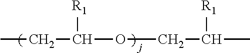

wherein
each R1 is selected from hydrogen, methyl and ethyl; and
j is an integer from 0 to about 400, optionally from 2 to about 50;
(c) and mixtures thereof.
C) The first hydrophobic conditioning compound and or second hydrophobic conditioning compound can be according to any of Paragraphs A) through B) wherein the branched polyester polymer having Formula 1 and Formula 2 each have a weight average molecular weight of from about 1000 Da to about 100000 Da, optionally from about 1000 Da to about 60000 Da, optionally from about 1000 Da to about 10000 Da, optionally from about 1000 Da to about 5000 Da.
D) The first hydrophobic conditioning compound and or second hydrophobic conditioning compound can be according to any of Paragraphs A) through C), wherein each A of the polyester polymers is independently a branched hydrocarbon having the structure

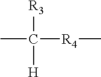

wherein each R3 is a monovalent alkyl or substituted alkyl group and R4 is an unsaturated or saturated divalent alkylene radical comprising from 1 to about 24 carbon atoms, optionally each R3 is a monovalent alkyl radical comprising 6 carbon atoms and each R4 is an unsaturated or saturated divalent alkylene radical comprising from 10 carbon atoms.
E) The first hydrophobic conditioning compound and or second hydrophobic conditioning compound can be according to any of Paragraphs A) through D), wherein each A of the polyester polymers has the structure:

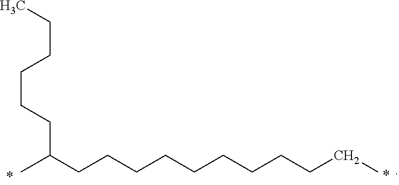 [SMILES: CCCCCCCCCCCC(C)CCCCCC]

F) The first hydrophobic conditioning compound and or second hydrophobic conditioning compound can be according to any of Paragraphs A) through E) wherein the branched polyester polymer has an iodine value from about 0 to about 90, optionally from about 0.4 to about 50 an optionally from about 1 to about 30.

The first hydrophobic conditioning compound or second hydrophobic conditioning compound can be a silicone. Useful silicones can be any silicone comprising compound. In one embodiment, the silicone is a silicone polymer selected from the group of cyclic silicones, polydimethylsiloxanes, aminosilicones, cationic silicones, silicone polyethers, silicone resins, silicone urethanes, and mixtures thereof. In one embodiment, the silicone is a polydialkylsilicone, alternatively a polydimethyl silicone (polydimethyl siloxane or “PDMS”), or a derivative thereof. In another embodiment, the silicone is chosen from an aminofunctional silicone, polyether silicone, alkyloxylated silicone, cationic silicone, ethoxylated silicone, propoxylated silicone, ethoxylated/propoxylated silicone, or combinations thereof.

In another embodiment, the silicone may be chosen from a random or blocky organosilicone polymer having the following formula:

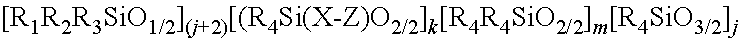

wherein:
j is an integer from 0 to about 98; in one aspect j is an integer from 0 to about 48; in one aspect, j is 0; k is an integer from 0 to about 200, in one aspect k is an integer from 0 to about 50; when k=0, at least one of R₁, R₂ or R₃ is —X—Z;
m is an integer from 4 to about 5000; in one aspect m is an integer from about 10 to about 4000; in another aspect m is an integer from about 50 to about 2000;
R₁, R₂ and R₃ are each independently selected from the group of H, OH, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, C₁-C₃₂ alkoxy, C₁-C₃₂ substituted alkoxy and X-Z;
each R₄ is independently selected from the group of H, OH, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, C₁-C₃₂ alkoxy and C₁-C₃₂ substituted alkoxy;
each X in the alkyl siloxane polymer comprises a substituted or unsubstituted divalent alkylene radical comprising 2-12 carbon atoms, in one aspect each divalent alkylene radical is independently selected from the group of —(CH₂)ₛ— wherein s is an integer from about 2 to about 8, from about 2 to about 4; in one aspect, each X in the alkyl siloxane polymer comprises a substituted divalent alkylene radical selected from the group of: —CH₂—CH(OH)—CH₂—; —CH₂—CH₂—CH(OH)—; and

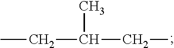

each Z is selected independently from the group of

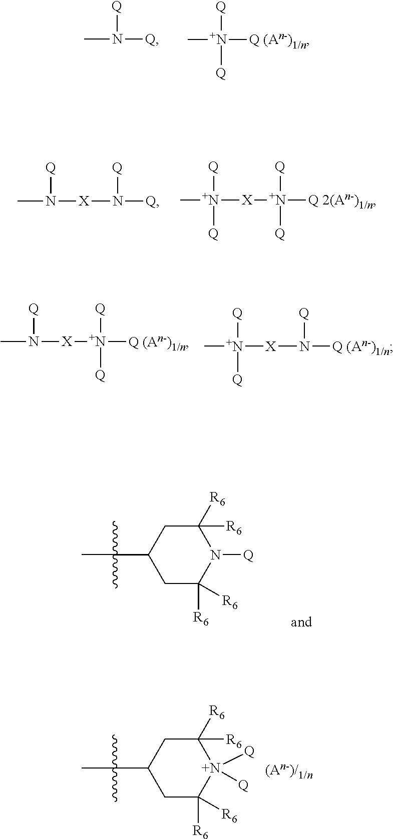

with the proviso that when Z is a quat, Q cannot be an amide, imine, or urea moiety and if Q is an amide, imine, or urea moiety, then any additional Q bonded to the same nitrogen as the amide, imine, or urea moiety must be H or a C₁-C₆ alkyl, in one aspect, the additional Q is H; for Z Aⁿ⁻ is a suitable charge balancing anion. In one aspect Aⁿ⁻ is selected from the group of Cl⁻, Br⁻, I⁻, methylsulfate, toluene sulfonate, carboxylate and phosphate; and at least one Q in the organosilicone is independently selected from
—CH₂—CH(OH)—CH₂—R₅;

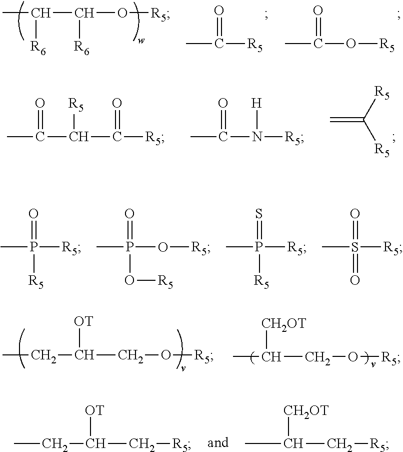

each additional Q in the organosilicone is independently selected from the group comprising of H, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, —CH₂—CH(OH)—CH₂—R₅;

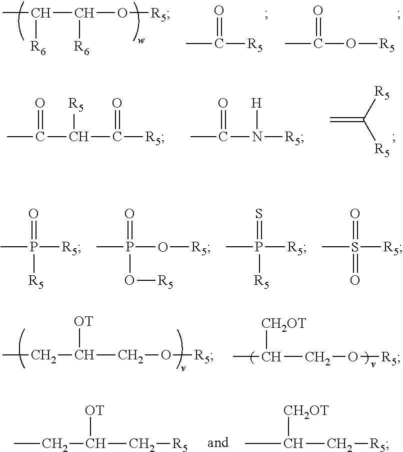

wherein each R₅ is independently selected from the group of H, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, —(CHR₆—CHR₆—O—)_{w}-L and a siloxyl residue;
each R₆ is independently selected from H, C₁-C₁₈ alkyl;
each L is independently selected from —C(O)—R₇ or;
R₇;
w is an integer from 0 to about 500, in one aspect w is an integer from about 1 to about 200; in one aspect w is an integer from about 1 to about 50;
each R₇ is selected independently from the group of H; C₁-C₃₂ alkyl; C₁-C₃₂ substituted alkyl, C₅-C₃₂ or C₆-C₃₂ aryl, C₅-C₃₂ or C₆-C₃₂ substituted aryl, C₆-C₃₂ alkylaryl; C₆-C₃₂ substituted alkylaryl and a siloxyl residue;
each T is independently selected from H, and

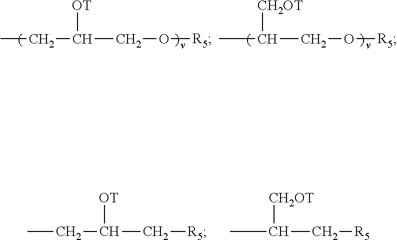

and
wherein each v in the organosilicone is an integer from 1 to about 10, in one aspect, v is an integer from 1 to about 5 and the sum of all v indices in each Q in the organosilicone is an integer from 1 to about 30 or from 1 to about 20 or even from 1 to about 10.

In another embodiment, the silicone may be chosen from a random or blocky organosilicone polymer having the following formula:

[R₁R₂R₃SiO_{1/2}]₍ⱼ₊₂₎>[(R₄Si(X—Z)O_{2/2}]ₖ[R₄R₄SiO_{2/2}]ₘ[R₄SiO_{3/2}]ⱼ
wherein
j is an integer from 0 to about 98; in one aspect j is an integer from 0 to about 48; in one aspect, j is 0;
k is an integer from 0 to about 200; when k=0, at least one of R₁, R₂ or R₃=—X—Z, in one aspect, k is an integer from 0 to about 50
m is an integer from 4 to about 5000; in one aspect m is an integer from about 10 to about 4000; in another aspect m is an integer from about 50 to about 2000;
R₁, R₂ and R₃ are each independently selected from the group of H, OH, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, C₁-C₃₂ alkoxy, C₁-C₃₂ substituted alkoxy and X—Z;
each R₄ is independently selected from the group of H, OH, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, C₁-C₃₂ alkoxy and C₁-C₃₂ substituted alkoxy;
each X comprises of a substituted or unsubstituted divalent alkylene radical comprising 2-12 carbon atoms; in one aspect each X is independently selected from the group of —(CH₂)ₛ—O—; —CH₂—CH(OH)—CH₂—O—;

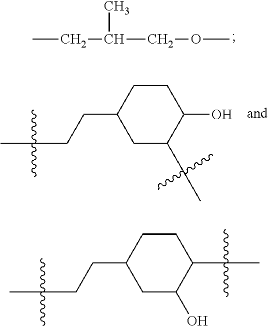

wherein each s independently is an integer from about 2 to about 8, in one aspect s is an integer from about 2 to about 4;
at least one Z in the organosiloxane is selected from the group of R₅;

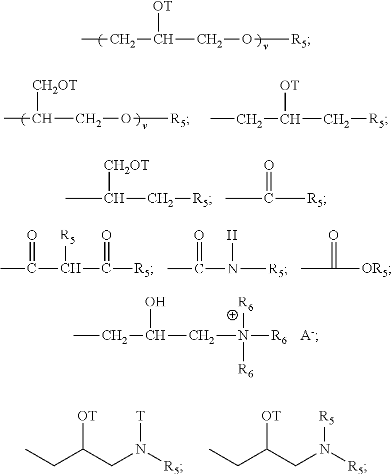

—C(R₅)₂R₅; —C(R₅)₂S—R₅ and

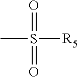

provided that when X is or

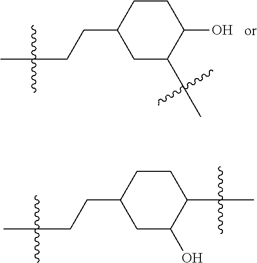 [SMILES: *CCC1CCC(O)C(*)C1 ; *CCC1CCC(*)C(O)C1]

### the Z=—OR₅ or

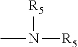

wherein A⁻ is a suitable charge balancing anion. In one aspect A⁻ is selected from the group of Cl⁻, Br⁻, I⁻, methylsulfate, toluene sulfonate, carboxylate and phosphate and each additional Z in the organosilicone is independently selected from the group comprising of H, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, R₅,

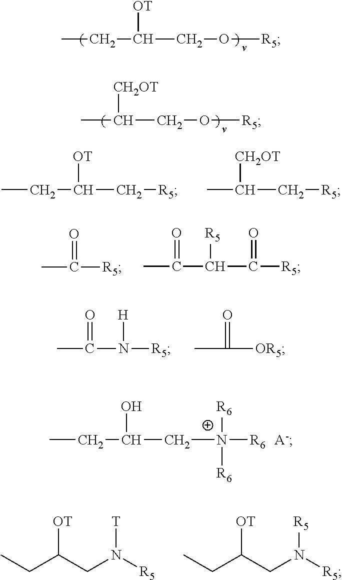

—C(R₅)₂O—R₅; —C(R₅)₂S—R₅ and

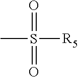

provided that when X is

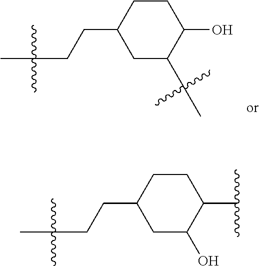 [SMILES: *CCC1CCC(O)C(*)C1 ; *CCC1CCC(*)C(O)C1]

then Z=—OR₅ or

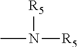

each R₅ is independently selected from the group of H; C₁-C₃₂ alkyl; C₁-C₃₂ substituted alkyl, C₅-C₃₂ or C₆-C₃₂ aryl, C₅-C₃₂ or C₆-C₃₂ substituted aryl or C₆-C₃₂ alkylaryl, or C₆-C₃₂ substituted alkylaryl, —(CHR₆—CHR₆—O—)_{w}—CHR₆—CHR₆-L and siloxyl residue wherein each L is independently selected R₇ HH from —O—C(O)—R₇ or —O—R₇;

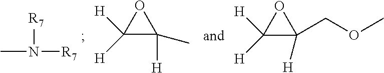

w is an integer from 0 to about 500, in one aspect w is an integer from 0 to about 200, one aspect w is an integer from 0 to about 50;
each R₆ is independently selected from H or C₁-C₁₈ alkyl;
each R₇ is independently selected from the group of H; C₁-C₃₂ alkyl; C₁-C₃₂ substituted alkyl, C₅-C₃₂ or C₆-C₃₂ aryl, C₅-C₃₂ or C₆-C₃₂ substituted aryl, C₆-C₃₂ alkylaryl, and C₆-C₃₂ substituted aryl, and a siloxyl residue;
each T is independently selected from H;

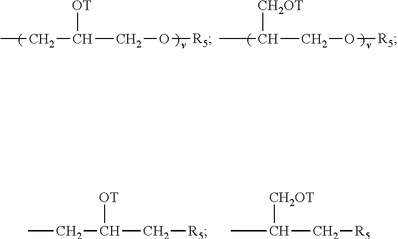

wherein each v in the organosilicone is an integer from 1 to about 10, in one aspect, v is an integer from 1 to about 5 and the sum of all v indices in each Z in the organosilicone is an integer from 1 to about 30 or from 1 to about 20 or even from 1 to about 10.

The silicone can be one comprising a relatively high molecular weight. A suitable way to describe the molecular weight of a silicone includes describing its viscosity. A high molecular weight silicone is one having a viscosity of from about 10 cSt to about 3000000 cSt, or from about 100 cSt to about 1000000 cSt, or from about 1000 cSt to about 600000 cSt, or even from about 6000 cSt to about 300000 cSt.

### Salt

The plurality of particles can comprise from about 5% to about 50%, optionally from 8% to 25%, optionally from 15% to 30% by weight, said nonhalide salt, including any range within one of the aforesaid ranges as bounded by whole numbers of percent. For example, the plurality of particles can comprise from about 5% to about 50% by weight nonhalide salt, optionally from about 5% to about 30% by weight nonhalide salt, optionally from about 5% to about 25% by weight nonhalide salt, optionally from about 8% to about 24% by weight nonhalide salt, including any range within one of the aforesaid ranges as bounded by whole numbers of percent. The plurality of particles can comprise from about 10% to about 24% by weight nonhalide salt, optionally from about 15% to about 23% by weight nonhalide salt, optionally from about 18% to about 22% by weight nonhalide salt, including any range within one of the aforesaid ranges as bounded by whole numbers of percent. Optionally, the particles can comprise from about 25% to about 81% by weight the water soluble carrier and from about 8% to about 25% by weight nonhalide salt.

The nonhalide salt can be selected from alkali metal salt, an alkaline earth metal salt, an inorganic alkali metal salt, an organic alkali metal salt, an organic alkaline earth metal salt, or any combination thereof. The nonhalide salt can be an acidic salt, a basic salt, a carbonate salt, a carboxylate salt, a sulfate, nitrate salt, a citrate salt, or any combination thereof.

The nonhalide alkaline earth metal salts can include, for example, magnesium sulfate, magnesium phosphate, magnesium monohydrogen phosphate, magnesium dihydrogen phosphate, magnesium, carbonate, magnesium monohydrogen carbonate, magnesium acetate, magnesium citrate, magnesium lactate, magnesium tartrate, magnesium silicate, magnesium ascorbate, calcium sulfate, calcium phosphate, calcium monohydrogen phosphate, calcium dihydrogen phosphate, calcium carbonate, calcium monohydrogen carbonate, calcium acetate, calcium citrate, calcium lactate, calcium tartrate, calcium silicate, calcium ascorbate, or any combination thereof.

The salt can be a nonhalide salt. The nonhalide salt and its hydrates can be selected from the group of magnesium sulfate, ammonium sulfate, ammonium nitrate ammonium acetate, magnesium acetate, zinc sulfate monohydrate, magnesium sulfate heptahydrate, sodium acetate, sodium acetate trihydrate, calcium acetate, calcium acetate dihydrate, calcium sulfate, aluminum sulfate, zinc acetate, magnesium nitrate hexahydrate, magnesium acetate tetrahydrate, sodium sulfate decahydrate, sodium citrate, sodium carbonate, calcium citrate, calcium citrate tetrahydrate, and combinations thereof.

The nonhalide salt can be dispersed in the water soluble carrier. The nonhalide salt can be uniformly dispersed or randomly dispersed in the water soluble carrier. The nonhalide salts are characterized by a particle size less than 600 microns, optionally from 50 microns to 600 microns, optionally from 50 microns to 420 microns. The mean particle size of the nonhalide salts can be characterized by passing the salt material through sieves having different mesh sizes.

The nonhalide salt can chemically differ from the water soluble carrier.

### Nonionic Surfactants

The nonionic surfactant can be selected from alcohol alkoxylate non-ionic surfactant, including naturally derived alcohol, synthetic derived alcohol based alcohol alkoxylate non-ionic surfactants, and mixtures thereof, pending the desired average alkyl carbon chain length and average degree of branching. The alcohol alkoxylate nonionic surfactant can be a primary or a secondary alcohol alkoxylate nonionic surfactant, optionally a primary alcohol alkoxylate nonionic surfactant. Synthetically derived alcohol alkoxylate non-ionic surfactants include Ziegler-synthesized alcohol alkoxylate, an oxo-synthesized alcohol alkoxylate, a modified oxo-process synthesized alcohol alkoxylate, Fischer-Tropsch synthesized alcohol alkoxylates, Guerbet alcohol alkoxylates, alkyl phenol alcohol alkoxylates, or a mixture thereof. The alkoxylation chain can be a mixed alkoxylation chain comprising ethoxy, propoxy and/or butoxy units, or can be a purely ethoxylated alkyl chain, optionally a purely ethoxylated alkyl chain.

Suitable nonionic surfactant may include alkoxylated fatty alcohols. The nonionic surfactant may be selected from ethoxylated alcohols and ethoxylated alkyl phenols of the formula R(OC2H4), OH, wherein R is selected from the group consisting of aliphatic hydrocarbon radicals containing from about 8 to about 15 carbon atoms and alkyl phenyl radicals in which the alkyl groups contain from about 8 to about 12 carbon atoms, and the average value of n is from about 5 to about 15.

Other non-limiting examples of nonionic surfactants useful herein include: C8-C18 alkyl ethoxylates, such as, NEODOL nonionic surfactants from Shell; C6-C12 alkyl phenol alkoxylates where the alkoxylate units may be ethyleneoxy units, propyleneoxy units, or a mixture thereof; C12-C18 alcohol and C6-C12 alkyl phenol condensates with ethylene oxide/propylene oxide block polymers such as PLURONIC from BASF; C14-C22 mid-chain branched alcohols, BA; C14-C22 mid-chain branched alkyl alkoxylates, BAEX, wherein x is from 1 to 30; alkylpolysaccharides; specifically alkylpolyglycosides; polyhydroxy fatty acid amides; and ether capped poly(oxyalkylated) alcohol surfactants. Specific examples include C11-C15 EO12 and C11-C15 EO9 TERGITOL nonionic surfactants from Dow, C12-C15 EO7 and C14-C15 EO7 NEODOL nonionic surfactants from Shell, C12-C14 EO7 and C12-C14 EO9 SURFONIC nonionic surfactants from Huntsman. Other suitable nonionic surfactants are the condensation products of Guerbet alcohols with from 2 to 18 moles, optionally 2 to 15, optionally 5-9 of ethylene oxide per mole of alcohol. Suitable nonionic surfactants include those with the trade name LUTENSOL from BASF. LUTENSOL XP-50 is a Guerbet ethoxylate that contains 5 ethoxy groups. LUTENSOL XP-80 and containing 8 ethoxy groups. Other suitable non-ionic surfactants for use herein include fatty alcohol polyglycol ethers, alkylpolyglucosides and fatty acid glucamides, and/or alkylpolyglucosides based on Guerbet alcohols.

The nonionic surfactant may comprise linear surfactants, branched surfactants, or mixtures thereof, optionally linear nonionic surfactants, branched nonionic surfactants, or mixtures thereof. Suitable linear surfactants may include C12-C14 EO9 SURFONIC (ex Huntsman). Suitable branched surfactants may include TERGITOL 15-S-3 (ex Dow), TERGITOL 15-S-5 (ex Dow), TERGITOL 15-5-9 (ex Dow), TERGITOL 15-5-12 (ex Dow), and LUTENSOL XL70 (ex BASF).

A suitable nonionic surfactant can have a HLB from 8 to 15. Optionally, a suitable nonionic surfactant can have a molecular weight less than 1000 Da. Particles

The individual particles constituting the plurality of particles can have individual mass from about 1 mg to about 1 g. The smaller the individual particles the faster they tend to dissolve in water. The individual particles constituting the plurality of particles can have an individual or mean particle mass of from about 1 mg to about 1000 mg, alternatively from about 5 mg to about 500 mg, alternatively from about 5 mg to about 200 mg, alternatively from about 10 mg to about 100 mg, alternatively from about 20 mg to about 50 mg, alternatively from about 35 mg to about 45 mg, alternatively about 38 mg. The individual particles constituting the plurality of particles can have standard deviation of mass of less than about 30 mg, alternatively less than about 15 mg, alternatively less than about 5 mg, alternatively about 3 mg. The mean particle of mass within the aforesaid ranges can provide for a dispersion time in water that permits the particles to dissolve during a typical wash cycle. Without being bound by theory, it is thought that particles have such a standard deviation of mass can have a more uniform dispersion time in water as compared to particles having a broader standard deviation of mass. The smaller the standard deviation of mass of the particles the more uniform the dispersion time. The mass of the individual particles forming the plurality particles can be set to provide the desired dispersion time, which might be some fraction of the length of the typical washing cycle in a washing machine.

The plurality of particles can be substantially free from particles having a mass less than 10 mg. This can be practical for limiting the ability of the particles to become airborne.

An individual particle may have a volume from about 0.003 cm³ to about 5 cm³, optionally from about 0.003 cm³ to about 1 cm³, optionally from about 0.003 cm³ to about 0.5 cm³, optionally from about 0.003 cm³ to about 0.2 cm³, optionally from about 0.003 cm³ to about 0.15 cm³. Smaller particles are thought to provide for better packing of the particles in a container and faster dissolution in the wash.

The composition can comprise individual particles that are retained on a number 10 sieve as specified by ASTM International, ASTM E11-13. The composition can comprise individual particles wherein more than about 50% by weight, optionally more than about 70% by weight, optionally more than about 90% by weight, of the individual particles are retained on a number 10 sieve as specified by ASTM International, ASTM E11-13. It can be desirable to provide individual particles sized as such because individual particles retained on a number 10 sieve may be easier to handle than smaller individual particles.

The composition can comprise individual particles that are retained on a number 6 sieve as specified by ASTM International, ASTM E11-13. The composition can comprise individual particles wherein more than about 50% by weight, optionally more than about 70% by weight, optionally more than about 90% by weight, of the individual particles are retained on a number 6 sieve as specified by ASTM International, ASTM E11-13. It can be desirable to provide individual particles sized as such because individual particles retained on a number 6 sieve may be easier to handle than smaller individual particles.

The composition can comprise individual particles that pass a sieve having a nominal sieve opening size of 22.6 mm. The composition can comprise individual particles that pass a sieve having a nominal sieve opening size of 22.6 mm and are retained on a sieve having a nominal sieve opening size of 0.841 mm. Individual particles having a size such that they are retained on a sieve having a nominal opening size of 22.6 mm may tend to have a dispersion time that is too great for a common wash cycle. Individual particles having a size such that they pass a sieve having a nominal sieve opening size of 0.841 mm may be too small to conveniently handle. Individual particles having a size within the aforesaid bounds may represent an appropriate balance between dispersion time and ease of particle handling.

Individual particles having the size disclosed herein can be substantial enough so that they do not readily become airborne when poured from a container, dosing cup, or other apparatus, into a wash basin or washing machine. Further, such individual particles as disclosed herein might be able to be easily and accurately poured from a container into a dosing cup. So, such individual particles may make it easy for the consumer to control the amount of first hydrophobic conditioning compound and optional second hydrophobic conditioning compound he or she delivers to the wash.

A plurality of particles may collectively comprise a dose for dosing to a laundry washing machine or laundry wash basin. A single dose of the plurality of particles may comprise from about 1 g to about 50 g of particles. A single dose of the plurality of particles may comprise from about 5 g to about 50 g, alternatively from about 10 g to about 45 g, alternatively from about 20 g to about 40 g, alternatively combinations thereof and any whole numbers of grams or ranges of whole numbers of grams within any of the aforementioned ranges. The plurality of particles can be made up of individual particles having different size, shape, and/or mass. The individual particles in a dose can each have a maximum dimension less than about 15 mm. Individual particles in a dose can have a maximum dimension less than about 1 cm.

The plurality of particles can comprise an antioxidant. The antioxidant can help to promote stability of the color and or odor of the particles over time between production and use. The plurality of particles can comprise from about 0.01% to about 1% by weight antioxidant, optionally from about 0.001% to about 2% by weight antioxidant, optionally from about 0.01% to about 0.1% by weight antioxidant. The antioxidant can be butylated hydroxytoluene.

The particles can be formed via batch or continuous rotoforming process. Rotoforming processes are described in U.S. Pat. Nos. 5,013,498A, 5,770,235A US20110017130 A1, U.S. Ser. No. 10/465,048B2. The particles can be hemispherical, compressed hemispherical, or particles having at least one substantially flat or flat surface. The particles can have a flat surface and a curved surface opposite the flat surface. Such particles may have relatively high surface area to mass as compared to spherical particles.

The particles can be formed by forming a melt of the constituent materials of the particles and forming particles using a rotoforming process. The particles can be formed on a SANDVIK ROTOFORM 300 having a 750 mm wide 10 m long belt. The cylinder can have 2 mm diameter apertures set at a 10 mm pitch in the cross machine direction and 9.35 mm pitch in the machine direction. The cylinder can be set at approximately 3 mm above the belt. The belt speed and rotational speed of the cylinder 110 can be set at 10 m/min.

After forming the melt, or example using a batch process or a continuous inline process or combination thereof, the precursor material can be pumped at a constant 3.1 kg/min rate, or even a 4 kg/min rate, through a plate and frame heat exchanger set to control the outlet temperature to 50° C. The pressure in the feed pipe downstream of the pump can be about 2 to about 7 bar, and alternatively about 5.5 bar or about 5 bar.

The practicality of processing melts can at least partially depend on the viscosity of the melt. For any of the compositions described herein, it can be desirable for the compositions to have a viscosity from about 1 Pa-s to about 10 Pa-s at 65 C, from about 1 Pa-s to about 5 Pa-s at 65 C, optionally from about 1.5 to about 4, optionally from about 1 Pa-s to about 3 Pa-s, optionally about 2. Such compositions may be conveniently processed on a rotoformer and yield particles having a desired shape.

The viscosity can be controlled, by way of nonlimiting example, by adding a diluent to the composition. The plurality of particles and or individual particles can comprise a diluent. The diluent can be selected from the group of dipropylene glycol, fatty acid, and combinations thereof.

The plurality of particles can comprise individual particles that comprise at least one of the first hydrophobic conditioning compound, the optional second hydrophobic conditioning compound, the cationic polysaccharide, and the salt. The individual particles can comprise one or more of the first hydrophobic conditioning compound, the optional second hydrophobic conditioning compound, the cationic polysaccharide, and the salt. The individual particles can differ from one another in weight fraction of at least one of the first hydrophobic conditioning compound, the optional second hydrophobic conditioning compound, the cationic polysaccharide, and the salt. The individual particles can differ from one another in weight fraction of one or more of the first hydrophobic conditioning compound, the optional second hydrophobic conditioning compound, the cationic polysaccharide, and the salt. Providing particles that differ from one another in weight fraction of at least one of the first hydrophobic conditioning compound, the optional second hydrophobic conditioning compound, the cationic polysaccharide, and the salt can simplify the manufacturer's ability to provide multiple variants of the composition of the plurality of particles.

Optionally, the individual particles can comprise of the first hydrophobic conditioning compound, the optional second hydrophobic conditioning compound, the cationic polysaccharide, and the salt. The individual particles can each be compositionally the same as one another. Optionally, the individual particles can comprise the same constituents but differ from one another in weight fraction of the constituents. Such an arrangement may be helpful for providing products that differ from one another by the amount of consumer benefit provided. For example, highly active particles and moderately active particles can be blended together to provide a consumer benefit that is intermediate the consumer benefit provided by the highly active particles alone or the moderately active particles alone.

The manufacturer can form up the plurality of particles by blending different weight fractions of the individual particles to arrive at the desired levels of the first hydrophobic conditioning compound and the optional second hydrophobic conditioning compound. For example, the manufacture can make a first set of individual particles that comprise the water soluble carrier and the first hydrophobic conditioning compound and be substantially free from or free from the cationic polysaccharide or some weight fraction of the cationic polysaccharide other than the weight fraction of the cationic polysaccharide in the second set of particles. The manufacturer can also make a second set of individual particles the comprise the water soluble carrier and the cationic polysaccharide and be substantially free from or free from the first hydrophobic conditioning compound or some weight fraction of the first hydrophobic conditioning compound other than the weight fraction of the first hydrophobic conditioning compound in the first set of particles.

The manufacturer can then blend chosen weight fractions of the sets of individual particles to make the plurality of particles having the desired weight fraction of water soluble carrier, first hydrophobic conditioning compound, optional second hydrophobic conditioning compound, cationic polysaccharide, and salt. The manufacturer can assemble the plurality of particles with the desired weight fraction of the first hydrophobic conditioning compound and optional second hydrophobic conditioning compound to provide for the desired benefit for the composition of the plurality of particles. The desired weight fraction may be chosen on the basis of the level of softness desired, cost of the composition, typical wash conditions within a geography, different needs of different segments of a market, or other factors. This can reduce the number of formulas for which the manufacturer must maintain production expertise and control, the number of formulas the manufacturer must maintain and specify for certain production runs, and reduce the number of production disruptions to provide for variations in the composition of the plurality of particles.

### EXAMPLES

### Production of Particles

Particles were prepared by providing a 65:35 weight percent blend of PLURIOL E 8000 Prill Polyethylene Glycol having a weight average molecular weight of 9000 Da and Dow Carbowax Polyethylene Glycol having a weight average molecular weight of 4000 Da respectively in a MAX 100 SPEEDMIX cup and placing the cup of material in an oven having a temperature of 80° C. overnight to melt. The hydrophobic conditioning compound was placed in an oven at 80° C. for 30 minutes before adding it to the polyethylene glycol blend. The MAX 100 SPEEDMIX cup of polyethylene glycol blend was removed from the oven in the morning before starting the production of particles. The hydrophobic conditioning compound, cationic polyglucan, and salt, if employed, were added to the MAX 100 SPEED MIX cup containing the melted polyethylene glycol blend. The contents of the MAX 100 SPEEDMIX cup were thoroughly mixed by swirling the contents with a spatula and placed immediately into a SPEEDMIXER DAC 150 FVC-K (FLAK TEK Inc.) for 60 seconds at 3500 revolutions per minute. The mixture was then immediately poured onto a rubber mold that was kept in a refrigerator at 4° C. and spread with a spatula into depressions in the rubber mold. The mixture hardened in the depressions of the rubber mold to form the particles. The hardened particles were removed from the rubber mold. The mold shape was an oblate hemisphere having a diameter of 5.0 mm and a height of 2.5. The specimen particles were stored at 23° C. and 50% relative humidity for 5 days before testing for softness performance.

### Process for Treating an Article of Clothing

To assess the softness performance of the particles disclosed herein, fabrics were prepared/treated through the wash sub-cycle according to the following method.

### A. Equipment and Materials

Fabrics were assessed using Kenmore FS 600 and/or 80 series washing machines. Washin machines are set at: 20° C./20° C. wash/rinse temperature, 3 grains per gallon hardness water, normal cycle, and small load (46 liters). Fabric bundles consisted of 2.4 kilograms of clean fabric consisting of 50% cotton and 50% polycotton ballast (9 cotton, 9 polycotton). Test swatches were included with this bundle and comprised of 3-100% cotton (479) and 3-50%/50% polycotton (7422) fabrics ordered from Test Fabrics.

### B. Stripping and Desizing

Prior to treatment with any test products, the fabric bundles were stripped according to the Fabric Preparation-Stripping and Desizing procedure before running the test.

The Fabric Preparation-Stripping and Desizing procedure included washing the fabric bundle (2.7-3.6 Kg of fabric consisting of 50% cotton and 50% polycotton ballast) for 5 consecutive wash cycles, where only the first 2 cycles were done with a liquid detergent in 140° F. (60° C.) soft water. A liquid detergent containing alcohol ethoxysulfates, linear alkylbenzene sulfonate, C12-C16 alcohol ethoxylate AE9, fatty acids, and other minors was used to strip/de-size the test swatch fabrics and fabric bundle. Cycles 3-5 were washed without detergent in 1400 F (60° C.) soft water. After the fifth wash and rinse cycle the fabric bundle was transfer to Kenmore dryers on high setting for 50 minutes. The wash conditions were as follows: TL Kenmore 600 and/or 80 series wash machines (or equivalent), set at: 60° C./60° C. wash/rinse temperature, soft water, heavy duty cycle, and 22 gallon fill. The dryer timer was set for 50 minutes on the cotton/high/timed dry setting.

### C. Test Treatment

Fabrics were treated by adding a dose of 82 g of a Tide perfume free (nil enzyme, nil dye, 1.9% alcohol ethoxysulfates, 10.1% linear alkylbenzene sulfonate, 3.5% sodium lauryl sulfate, 0.3% amine oxide and 10.5% non-ionic Surfactants) liquid detergent and 37 g of the specimen particles. The detergent was added under the surface of the water while the machine was filling water into the drum. Once the water stopped flowing and the washer began to agitate, 37 g of the specimen particles was added to the wash liquor. After 5 seconds of agitation the machine was stopped and the clean fabric bundle was added. Then the wash cycle was resumed. When the wash/rinse cycle was complete, each wet fabric bundle was transferred to a corresponding dryer. The dryer used was a Maytag commercial series (or equivalent) electric dryer, with the timer set for 50 minutes on the cotton/high heat/timed dry setting. After the drying cycle was complete, the test fabrics were then placed in a constant temperature/relative humidity (21° C., 50% relative humidity) controlled room for 12 to 24 hours and then evaluated for softness performance.

### Secant Modulus Instron Method

The Secant Modulus was measured using a Tensile and Compression Tester Instrument, Instron Model 5565 (Instron Corp., Norwood, Massachusetts, U.S.A.). The instrument was configured depending on the fabric type by selecting the following settings: the mode was Tensile Extension; the Waveform Shape was Triangle; the Maximum Strain was 10% for 479 and 494 100% Cotton Woven and 35% for 7422 50:50 Polycotton Knitted; the Rate was 0.83 mm/sec for 100% Cotton Woven and 2.5 mm/sec for Polycotton Knitted; the number of Cycles was 4; and the Hold time was 15 seconds between cycles. Fabrics were prepared and evaluated as per the following steps.
1. With scissors, cut serged edge of one entire side of each swatch in the warp direction and carefully peel off strings without stressing the fabric until an even edge is achieved.
2. Place a fabric press die that cuts strips 1″ wide and at least 4″ long parallel to the even edge and cut strips lengthwise in the warp direction.
3. Cut 3 strips of 100% Cotton Woven or Polycotton Knitted test fabric from 3 separate fabric swatches per treatment. Condition fabrics in a constant temperature (70° F.) and humidity (50% RH) room for at least 6 hours before analysis.
4. Clamp the top and then the bottom of fabric strip into the 2.54 cm grips on the tensile tester instrument with a 2.54 cm gap setting, loading a small amount of force (0.0.05N-0.2N) on the sample.
5. Release bottom clamp and re-clamp sample during the hold cycle, loading 0.05N-0.2N of force on the sample removing the slack by again loading the same force.
6. When 4 hysteresis cycles have been completed for the sample, the Secant Modulus is calculated at the maximum strain for each fabric type and average across the 9 swatches per treatment. The average secant modulus for the control fabric is subtracted from the average secant modulus of the test fabric specified in each experiment and then reported as Delta Secant Modulus. A positive Delta Secant Modulus indicates that the test fabric has a lower secant modulus than the control fabric. Fabrics that are more lubricated have a lower secant modulus which is perceived as softer than the respective control fabric. A negative Delta Secant Modulus indicates that the test fabric has a higher secant modulus than the control fabric. Fabrics that are less lubricated have a higher secant modulus which is perceived as less soft than the respective control fabric.

### Viscosity

The viscosity of a component of the consumer product composition, e.g. a hydrophobic conditioning compound or carrier material, is determined as follows.

For a given component, the viscosity reported is the viscosity value as measured by the following method, which generally represents the infinite-shear viscosity (or infinite-rate viscosity) of the component. Viscosity measurements are made with a TA Discovery HR-2 Hybrid Rheometer (TA Instruments, New Castle, Delaware, U.S.A.), and accompanying TRIOS software version 3.0.2.3156. The instrument is outfitted with a 40 mm stainless steel Parallel Plate (TA Instruments, cat. #511400.901), Peltier plate (TA Instruments cat. #533230.901), and Solvent Trap Cover (TA Instruments, cat. #511400.901). The calibration is done in accordance with manufacturer recommendations. A refrigerated, circulating water bath set to 25° C. is attached to the Peltier plate. The Peltier Plate temperature is set to 65° C. The temperature is monitored within the Control Panel until the instrument reaches the set temperature, then an additional 5 minutes is allowed to elapse to ensure equilibration before loading sample material onto the Peltier plate.

To load a liquid material (e.g. a hydrophobic conditioning compound), pre-melt the sample in an oven set to 70 C, and use a transfer pipette is used to transfer 2 ml of the liquid material onto the center surface of the Peltier plate. To load a non-liquid material (e.g. a carrier material), 2 grams of non-liquid material is added onto the center surface of the Peltier plate, and the sample is allowed to completely liquefy. If the loaded sample liquid contains visible bubbles, a period of 10 minutes is waited to allow the bubbles to migrate through the sample and burst, or a transfer pipette can be used to extract the bubbles. If bubbles still remain, then the sample is removed from the plate, the plate is cleaned with isopropanol wipe and the solvent is allowed to evaporate away. The sample loading procedure is then attempted again and repeated until a sample is loaded successfully without containing visible bubbles.

The parallel plate is lowered into position in several stages, with the gap distance initially set at 50 millimeters. After waiting 60 seconds with the plate at that gap distance, the parallel plate is further lowered into position with the gap distance set at 1 millimeter.

After the parallel plate is locked, any excess sample material is removed from the perimeter of the parallel plate using rubber policeman. It is important to ensure that the sample is evenly distributed around the edge of the parallel plate and there is no sample on the side or top of plate. If there is sample material on the side or top of the plate, this excess material is gently removed. The Solvent Trap Cover is carefully applied over the parallel plate.

The Instrument Procedures and Settings (IPS) used are as follows:
1) Conditioning Step (pre-condition the sample) under the “Environmental Control” label: “Temperature” is 65° C., “Inherit set point” is not selected, “Soak time” is 10.0 s, “Wait for temperature” is selected; under the “Wait for axial force” label: “Wait for axial force” is not selected; under the “Preshear options” label: “Perform preshear” is not selected; under the “Equilibration” label: “Perform equilibration” is selected, and “Duration” is 120 s.
2) Flow Peak Hold Step under the “Environmental Control” label: “Temperature is 25° C., “Inherit set point” is selected, “Soak time” is 0.0 s, “Wait for temperature” is not selected; under the “Test Parameters” label: “Duration” is 60 sec, “Shear rate” is 2.76 1/sec, “Inherent initial value” is not selected, “Number of points” is 20; under the “Controlled Rate Advanced” label: “Motor mode” is Auto; under the “Data acquisition” label: “End of Step” is Zero Torque, “Fast Sampling” and “Save image” are not selected; under the “Step termination” label: “Label checking: Enabled” is not selected, nor are “Equilibrium: Enabled” or “Step Repeat: Enabled” selected.
3) To measure the viscosity of the sample at additional temperatures, Step #1 above “Conditioning Step” is programed as the next step, and the “Temperature” is set to 60 C (under the “Environmental Control”). All other parameters are kept the same.
4) Flow Peak Hold Step is repeated exactly as written in Step #2 above, for this new temperature.
5) Steps #3 and #4 are continued using the following temperatures in the Conditioning Step: 55° C., 53° C., 52° C., 51° C., 50° C., 49° C., 48° C.

After collecting the data, the data set is opened in the TRIOS software. The data points are analyzed in the following way:
In the Peak Hold tab of the data, select Peak Hold−1 (corresponding to the data obtained at 65° C.). Report the average (mean) value of the Viscosity as expressed in units of Pa-s.
If desired, repeat this analysis to obtain the average (mean) viscosity value for the additional temperatures evaluated.

The reported viscosity value of the component measured is the average (mean) viscosity from three independent viscosity measurements (i.e. three replicate sample preparations) and is expressed in units of Pa·s.

### Molecular Weight

Weight-average molecular weight (M_{w}) values were determined as follows. Sample molecular weights were determined on an Agilent 1260 HPLC system equipped with autosampler, column oven, and refractive index detector. The operating system was OpenLAB CDS ChemStation Workstation (A.01.03). Data storage and analysis were performed with Cirrus GPC offline, GPC/SEC Software for ChemStation, version 3.4. Chromatographic conditions are given in Table 1. In carrying out the calculation, the results were calibrated using polystyrene reference samples having known molecular weights. Measurements of M_{w} values vary by 5% or less. The molecular weight analyses were determined using a chloroform mobile phase.

TABLE 1
Chromatographic conditions.

| Parameter | Conditions |
|---|---|
| Column Set | Three ResiPore columns (Agilent #1113-6300) in |
| | series with guard column (Agilent #1113-1300) |
| | Particle size: 3 μm |
| | Column dimensions: 300 × 7.5 mm |
| Mobile Phase | Chloroform |
| Flow Rate | 1 mL/min, needle wash is included |
| Column Temperature | 40° C. |
| Injection Volume | 20 μL |
| Detector | Refractive Index |
| Detector | 40° C. |
| Temperature | |

Table 2 lists the molecular weights and the retention times of the polystyrene standards.

TABLE 2
Molecular weights and retention times of the polystyrene standards.

| | Average Reported MW | |
|---|---|---|
| Standard Number | Da | Retention Time (min) |
| 1 | 150000 | 19.11 |
| 2 | 100000 | 19.63 |
| 3 | 70000 | 20.43 |
| 4 | 50000 | 20.79 |
| 5 | 30000 | 21.76 |
| 6 | 9000 | 23.27 |
| 7 | 5000 | 23.86 |
| 8 | 1000 | 27.20 |
| 9 | 500 | 28.48 |

Particles listed in Table 3 were prepared in accordance with the method of making provided in this specification to evaluate the effect of adding salts on the efficacy of particles for delivering a fabric softening benefit. Fabrics were treated with the specimen particles and tumble dried in accordance with the process of treating a clothing article provided in the specification. After the wash process was completed, the fabrics were equilibrated in a controlled temperature and humidity room (21° C./50% relative humidity) overnight before evaluation. After fabrics were equilibrated, the secant modulus of the test fabrics was evaluated in accordance with the test method provided in the specification. It is believed that a delta secant modulus of at least 10 points on 494 and 479 100% cotton woven fabric or 0.5 points on 7422 50:50 polycotton knitted fabrics is needed for consumers to notice a softness benefit on the fabric relative to the control.

As shown in Table 4 and Table 5, the fabrics treated with particles containing a combinations of hydrophobic conditioning compounds, the listed weight percent of a cationic poly alpha-1,6 glucan ether polymer, and the listed weight percent of salts had a positive delta secant modulus versus fabrics treated with particles containing a combinations of hydrophobic conditioning compounds and listed weight percent of a cationic poly alpha-1,6 glucan ether polymer alone.

TABLE 3
Softness benefits provided by particles consisting of 8% by weight of
hydrophobic conditioning compound¹, 12.5% by weight of hydrophobic
conditioning compound², the listed weight percent of the cationic
poly alpha-1,6 glucan ether polymer, the listed weight of a variety of
salts, 1% by weight of nonionic surfactant³, and balance of
polyethylene glycol blend.

| | | Poly alpha-1,6-glucan ether | | |
|---|---|---|---|---|
| | Weight % | Backbone | | Degree of |
| | Cationic | MW | Cationic | Branching |
| Example | Polyglucan | (kDa) | DoS | (alpha-1,2) |
| Control A | 3.50 | 185 | 0.15 | 5% |
| Example 1 | 3.50 | 185 | 0.15 | 5% |
| Example 2 | 3.50 | 185 | 0.15 | 5% |
| Control B | 3.50 | 185 | 0.07 | 5% |
| Example 3 | 3.50 | 185 | 0.07 | 5% |
| Control C | 7.00 | 185 | 0.07 | 5% |
| Example 4 | 7.00 | 185 | 0.07 | 5% |

| Example | Weight % of Salt | Type of Salt⁴ |
|---|---|---|
| Control A | — | — |
| Example 1 | 25 | Sodium Sulfate |
| Example 2 | 13.5 | Ammonium Acetate |
| Control B | — | — |
| Example 3 | 21.1 | Magnesium Sulfate |
| Control C | — | — |
| Example 4 | 21.1 | Magnesium Sulfate |

¹Amino-functional organosiloxane as described in Examples 1 to 4 of U.S. patent application U.S. Pat. No. 8,940,284 with an average molecular weight of 30,000 Da
²Branched polyesters as described in U.S. patent application U.S. Pat. No. 10,787,629 and/or U.S. Pat. No. 11,104,866 with an average molecular weight of 5,000 Da
³LUTENSOL XL-70, Polyoxyalkylene glycol based on Guerbet alcohol, CAS 166736-08-9 from BASF
⁴Magnesium sulfate anhydrous salt, 99.5% min powder, CAS. 7487-88-9, available from Alfa Aesar, Sodium sulfate anhydrous, CAS. 7757-82-6, available from Spectrum Chemical, and Ammonium Acetate salt, ≥98% granular, CAS. 631-61-8 from Sigma Aldrich.

TABLE 4
Softness benefits on 494 100% cotton woven and 7422 50:50 polycotton
knitted test fabrics provided by particles in Table 3.

| | Secant | Delta Secant | Secant | Delta Secant |
|---|---|---|---|---|
| | Modulus | Modulus vs. | Modulus | Modulus vs. |
| | Control (494 | Control (494 | (7422 | Control (7422 |
| | 100% Cotton | 100% Cotton | Polycotton | Polycotton |
| Example | Woven) | Woven) | Knitted) | Knitted) |
| Control A | 155 MPa | Ref. | 5.43 MPa | Ref. |
| Control A vs. | — | +11 | — | +2.26 |
| Example 1 | | | | |
| Control A vs. | — | +13 | — | +1.83 |
| Example 2 | | | | |

TABLE 5
Softness benefits on 479 100% cotton woven and 7422 50:50 polycotton
knitted test fabrics provided by particles in Table 3

| | Secant | Delta Secant | Secant | Delta Secant |
|---|---|---|---|---|
| | Modulus | Modulus vs. | Modulus | Modulus vs. |
| | Control (479 | Control (479 | (7422 | Control (7422 |
| | 100% Cotton | 100% Cotton | Polycotton | Polycotton |
| Example | Woven) | Woven) | Knitted) | Knitted) |
| Control B | 222 MPa | Ref. | 6.58 | Ref. |
| Control B vs. | — | +38 | — | +1.26 |
| Example 3 | | | | |
| Control C | 199 MPa | Ref. | 4.61 | Ref. |
| Control C vs. | — | +31 | — | +0.41 |
| Example 4 | | | | |

### Combinations

An Example follows:
A. A composition comprising a plurality of particles, said plurality of particles comprising: about 25% to about 89% by weight a water soluble carrier;
about 5% to about 45% by weight a first hydrophobic conditioning compound having a weight average molecular weight greater than 1000 Da;
about 5% to about 50% by weight a nonhalide salt;
about 0.5% to about 10% by weight a deposition aid selected from the group of:
(1) a poly alpha-1,3-glucan ether compound having a weight average molecular weight of from 90000 Da to 350000 Da, and a degree of cationic substitution of from 0.03 to 1.0; (2) a poly alpha-1,6-glucan ether compound comprising a poly alpha-1,6-glucan substituted with at least one positively charged organic group, wherein the poly alpha-1,6-glucan comprises a backbone of glucose monomer units wherein at least 65% of the glucose monomer units are linked via alpha-1,6-glycosidic linkages, wherein the poly alpha-1,6-glucan ether compound has a degree of substitution of about 0.001 to about 3.0, and wherein the poly alpha-1,6-glucan ether compound is characterized by: a) a weight average molecular weight of from about 80000 to about 500000 Da, and/or b) having been derived from a poly alpha-1,6-glucan having a weight average molecular weight of from about 50000 Da to about 450000 Da, determined prior to substitution with the least one positively charged organic group; (3) a poly alpha-1,3, alpha-1,6-glucan ether compound having a weight average molecular weight of from 90000 Da to 350000 Da, and a degree of cationic substitution of from 0.03-1.0 optionally from 0.05-0.09, optionally 0.15 to 0.8 and optionally 0.07 to 0.11; and (4) combinations thereof;
and wherein individual particles of said plurality of particles have a mass from about 1 mg to about 1 g.
B. The composition according to Paragraph A, wherein said first hydrophobic conditioning compound comprises a branched polyester selected from the group of:
   a) a branched polyester having Formula 1

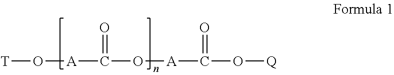

wherein:
each A is independently a branched hydrocarbon chain comprising 4 to 100 carbon atoms;
Q is selected from an alkyl chain comprising 1 to 30 carbon atoms and a hydrogen atom;
T is a hydrogen atom or a —C(O)—R wherein each R is an alkyl chain comprising 1 to 30 carbon atoms; and
n is an integer from 1 to about 100;
b) a branched polyester having Formula 2

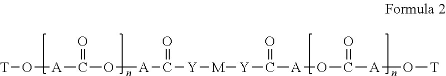

wherein:
each n is independently an integer from 1 to about 100;
each A is independently a branched hydrocarbon chain comprising 4 to 100 carbon atoms;
each T is independently a hydrogen atom or a —C(O)—R wherein each R is an alkyl chain comprising 1 to 30 carbon atoms;
each Y is independently a linking group selected from the group of oxygen and NR₂, wherein each R₂ is independently selected from the group of hydrogen, or a C1-C8 alkyl; and
M is a polyalkylene glycol group;
c) a branched polyester having Formula 3

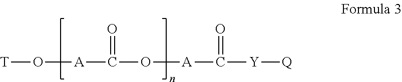

wherein:
   the index n is an integer from 1 to about 100;
   T is a hydrogen or —C(O)—R₁ where in R₁ is an alkyl chain comprising from 7 to 21 carbon atoms;
   each A is independently a branched hydrocarbon chain comprising from 4 to 40 carbon atoms;
   Y is selected from the group of oxygen and NR₂, wherein each R₂ is independently selected from the group of hydrogen, or a C₁-C₈ alkyl;
   Q is selected from the group of:
   i) B,
   ii) —Z—X—Z—W, and
   iii) —V—U—Z—X—Z—W;
wherein
   B is a substituted C₁-C₂₄ alkyl group;
   each Z is independently a substituted or unsubstituted divalent C₂-C₄₀ alkylene radical;
   X is polysiloxane moiety;
   W is selected from the group of —OR4,

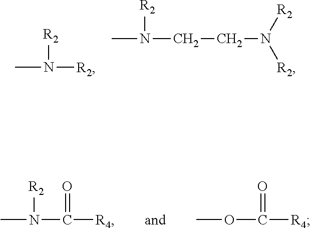

each R₂ is independently selected from the group of hydrogen or a C₁-C₈ alkyl;
R₄ is selected from a hydrogen atom, a C₁-C₂₄ alkyl group or a substituted C₁-C₂₄ alkyl group;
V is a C₁-C₂₄ divalent alkylene radical or a substituted C₁-C₂₄ divalent alkylene;
U is —C(O)O— or —C(O)NH—; and
d) a branched polyester having Formula 4

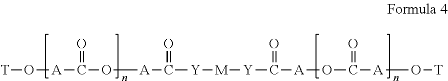

wherein:
   each index n is independently an integer from 1 to about 100;
   T is a hydrogen atom or —C(O)—R₁ where in R₁ is an alkyl chain comprising from 7 to 21 carbon atoms;
   each A is independently a branched hydrocarbon chain comprising from 4 to 40 carbon atoms;
   each Y is independently selected from the group of oxygen and NR₂, wherein each R₂ is independently selected from the group of hydrogen or a C₁-C₈ alkyl; M is selected from the group of:
   i) a C₁-C₂₄ divalent linear or branched alkylene radical;
   ii) —Z—X—Z—, and
   iii) -(D-U—Z—X—Z—U)ₘ-D-
   wherein:
   m is an integer from 1 to about 10;
   each Z is independently a substituted or unsubstituted divalent C₂-C₄o alkylene radical;
   X is polysiloxane moiety;
   U is —C(O)O— or —C(O)NH—; and
   each D is independently a C₁-C₂₄ divalent linear or branched alkylene radical;
e) and mixtures thereof.
C. The composition according to Paragraph A, wherein said first hydrophobic conditioning compound comprises silicone.
D. The composition according to any of Paragraphs A to C, wherein said plurality of particles further comprises a second hydrophobic conditioning compound having a weight average molecular weight greater than 1000 Da, optionally wherein said first hydrophobic conditioning compound and said second hydrophobic conditioning compound together constitute from about 6% to about 45% by weight of said composition.
E. The composition according to Paragraph D, wherein said first hydrophobic conditioning compound comprises a branched polyester selected from the group of:
   a) a branched polyester having Formula 1

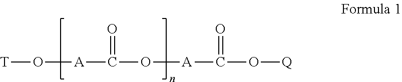

wherein:
each A is independently a branched hydrocarbon chain comprising 4 to 100 carbon atoms;
Q is selected from an alkyl chain comprising 1 to 30 carbon atoms and a hydrogen atom;
T is a hydrogen atom or a —C(O)—R wherein each R is an alkyl chain comprising 1 to 30 carbon atoms; and
n is an integer from 1 to about 100;
b) a branched polyester having Formula 2

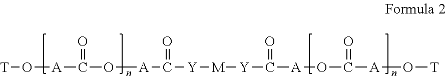

wherein:
each n is independently an integer from 1 to about 100;
each A is independently a branched hydrocarbon chain comprising 4 to 100 carbon atoms;
each T is independently a hydrogen atom or a —C(O)—R wherein each R is an alkyl chain comprising 1 to 30 carbon atoms;
each Y is independently a linking group selected from the group of oxygen and NR₂, wherein each R₂ is independently selected from the group of hydrogen, or a C₁-C₈ alkyl; and
M is a polyalkylene glycol group;
c) a branched polyester having Formula 3

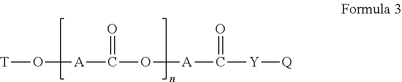

wherein:
   the index n is an integer from 1 to about 100;
   is a hydrogen or —C(O)—R₁ where in R₁ is an alkyl chain comprising from 7 to 21 carbon atoms;
   each A is independently a branched hydrocarbon chain comprising from 4 to 40 carbon atoms;
   Y is selected from the group of oxygen and NR₂, wherein each R₂ is independently selected from the group of hydrogen, or a C₁-C₈ alkyl;
   Q is selected from the group of:
   i) —B,
   ii) —Z—X—Z—W, and
   iii) —V—U—Z—X—Z—W
wherein
   B is a substituted C₁-C₂₄ alkyl group;
   each Z is independently a substituted or unsubstituted divalent C₂-C₄₀ alkylene radical;
   X is polysiloxane moiety;
   W is selected from the group of —OR₄,

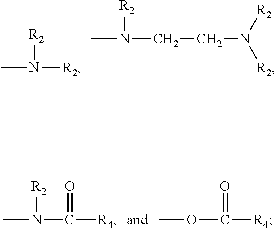

each R₂ is independently selected from the group of hydrogen or a C₁-C₈ alkyl;
R₄ is selected from a hydrogen atom, a C₁-C₂₄ alkyl group or a substituted C₁-C₂₄ alkyl group;
V is a C₁-C₂₄ divalent alkylene radical or a substituted C₁-C₂₄ divalent alkylene;
U is —C(O)O— or —C(O)NH—; and
d) a branched polyester having Formula 4

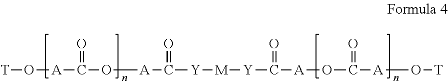

wherein:
   each index n is independently an integer from 1 to about 100;
   T is a hydrogen atom or —C(O)—R₁ where in R₁ is an alkyl chain comprising from 7 to 21 carbon atoms;
   each A is independently a branched hydrocarbon chain comprising from 4 to 40 carbon atoms;
   each Y is independently selected from the group of oxygen and NR₂, wherein each R₂ is independently selected from the group of hydrogen or a C₁-C₈ alkyl;
   M is selected from the group of:
   i) a C₁-C₂₄ divalent linear or branched alkylene radical;
   ii) —Z—X—Z—, and
   iii) -(D-U—Z—X—Z—U)ₘ-D-
   wherein:
   m is an integer from 1 to about 10;
   each Z is independently a substituted or unsubstituted divalent C₂-C₄o alkylene radical;
   X is polysiloxane moiety;
   U is —C(O)O— or —C(O)NH—; and
   each D is independently a C₁-C₂₄ divalent linear or branched alkylene radical;
e) and mixtures thereof.
F. The composition according to Paragraph D or E, wherein said second hydrophobic conditioning compound comprises silicone.
G. The composition according to any of Paragraphs D to F, wherein said plurality of particles comprises individual particles that comprise at least one of said first hydrophobic conditioning compound, said second hydrophobic conditioning compound, and said deposition aid; and wherein said individual particles differ from one another in weight fraction of at least one of said first hydrophobic conditioning compound, said second hydrophobic conditioning compound, and said deposition aid.
H. The composition according to any of Paragraphs D to G, wherein individual particles of said plurality of particles comprise said water soluble carrier, said first hydrophobic conditioning compound, said second hydrophobic conditioning compound, said poly alpha-1,6-glucan ether compound, and said salt.
I. The composition according to any of Paragraphs D to H, wherein said first hydrophobic conditioning compound is dispersed in said water soluble carrier.
J. The composition according to any of Paragraphs D to I, wherein said second hydrophobic conditioning compound is dispersed in said water soluble carrier.
K. The composition according to any of Paragraphs D to H, wherein said first hydrophobic conditioning compound and said second hydrophobic conditioning compound are dispersed in said water soluble carrier.
L. The composition according to Paragraph B or any of Paragraphs E to K, wherein for said Formula 1:
   each A is independently a branched hydrocarbon chain comprising from 4 to 40 carbon atoms;
   Q is selected from an alkyl chain comprising 1 to 30 carbon atoms and a hydrogen atom;
   T is a hydrogen atom or a —C(O)—R wherein each R is an alkyl chain comprising from 7 to 21 carbon atoms; and
   n is an integer from 4 to 40;
wherein for said Formula 2:
   n is an integer from 4 to 40;
   each A is independently a branched hydrocarbon chain comprising from 4 to 40 carbon atoms;
   each T is independently a hydrogen atom or a —C(O)—R wherein each R is an alkyl chain comprising from 7 to 21 carbon atoms;
   each Y is independently a linking group selected from the group of oxygen and NR₂, wherein each R₂ is independently selected from the group of hydrogen, or a C₁-C₈ alkyl;
   M is a polyalkylene glycol group having a structure of

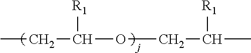

wherein:
each R₁ is selected from hydrogen, methyl and ethyl; and
j is an integer from 0 to about 400.
M. The composition according to Paragraph B or any of Paragraphs E to L, wherein said branched polyester polymer having Formula 1 and said branched polyester having Formula 2 each have a weight average molecular weight of from about 500 Da to about 100000 Da.
N. The composition according to Paragraph B or any of Paragraphs E to M, wherein each A of said branched polyester polymers is independently a branched hydrocarbon having the structure

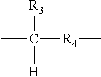

wherein each R₃ is a monovalent alkyl or substituted alkyl group and R₄ is an unsaturated or saturated divalent alkylene radical comprising from 1 to about 24 carbon atoms.
O. The composition according to Paragraph B or any of Paragraphs E to M, wherein each A of said branched polyester polymers has the structure:

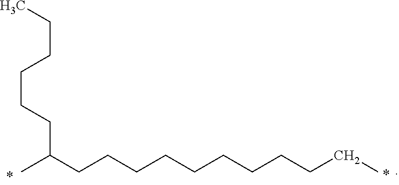 [SMILES: CCCCCCCCCCCC(C)CCCCCC]

P. The composition according to Paragraph B or any of Paragraphs E to O, wherein the branched polyester polymer has an iodine value from about 0 to about 90.
Q. The composition according to any of Paragraphs A to P, wherein said salt is selected from nonhalide sulfate, acetate, nitrate, and citrate salts optionally selected from the group of magnesium sulfate, ammonium nitrate, ammonium acetate, magnesium acetate tetrahydrate, ammonium sulfate, sodium acetate, zinc sulfate monohydrate, magnesium sulfate heptahydrate, sodium acetate trihydrate, calcium sulfate, calcium sulfate dihydrate, magnesium nitrate hexahydrate, magnesium acetate tetrahydrate, and sodium sulfate decahydrate, calcium citrate tetrahydrate, and combinations thereof.
R. The composition according to any of Paragraphs A to Q, wherein said water soluble carrier is selected from the group of polyethylene glycol, polypropylene glycol polyoxoalkylene, polyethylene glycol fatty acid ester, polyethylene glycol ether, nonionic starch, and mixtures thereof.
S. The composition according to any of Paragraphs A to R, wherein said water soluble carrier is polyethylene glycol having a weight average molecular weight from about 3500 Da to about 15000 Da.
T. The composition according to any of Paragraphs A to S, wherein said plurality of particles comprises from about 25% to about 81% by weight said water soluble carrier; and wherein said plurality of particles comprises from about 8% to about 25% by weight said nonhalide salt.
U. A process for treating an article of clothing comprising the steps of:
providing an article of clothing in a washing machine; and
contacting said article of clothing during a wash sub-cycle of said washing machine with a composition according to any of Paragraphs A to T.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed:

1. A composition comprising a plurality of particles, said plurality of particles comprising:
about 25% to about 89% by weight a water soluble carrier;
about 5% to about 45% by weight a first hydrophobic conditioning compound having a weight average molecular weight greater than 1000 Da;
about 5% to about 50% by weight a nonhalide salt;
about 0.5% to about 10% by weight a deposition aid selected from the group of:
(1) a poly alpha-1,3-glucan ether compound having a weight average molecular weight of from 90000 Da to 350000 Da, and a degree of cationic substitution of from 0.03 to 1.0; (2) a poly alpha-1,6-glucan ether compound comprising a poly alpha-1,6-glucan substituted with at least one positively charged organic group, wherein the poly alpha-1,6-glucan comprises a backbone of glucose monomer units wherein at least 65% of the glucose monomer units are linked via alpha-1,6-glycosidic linkages, wherein the poly alpha-1,6-glucan ether compound has a degree of substitution of about 0.001 to about 3.0, and wherein the poly alpha-1,6-glucan ether compound is characterized by: a) a weight average molecular weight of from about 80000 to about 500000 Da, and/or b) having been derived from a poly alpha-1,6-glucan having a weight average molecular weight of from about 50000 Da to about 450000 Da, determined prior to substitution with the least one positively charged organic group; (3) a poly alpha-1,3, alpha-1,6-glucan ether compound having a weight average molecular weight of from 90000 Da to 350000 Da, and a degree of cationic substitution of from 0.03 to 1.0; and (4) combinations thereof; and
wherein individual particles of said plurality of particles have a mass from about 1 mg to about 1 g.

2. The composition according to claim 1, wherein said first hydrophobic conditioning compound comprises a branched polyester selected from the group of:
a) a branched polyester having Formula 1 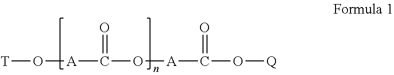
wherein:
each A is independently a branched hydrocarbon chain comprising 4 to 100 carbon atoms;
Q is selected from an alkyl chain comprising 1 to 30 carbon atoms and a hydrogen atom;
T is a hydrogen atom or a —C(O)—R wherein each R is an alkyl chain comprising 1 to 30 carbon atoms; and
n is an integer from 1 to about 100;
b) a branched polyester having Formula 2 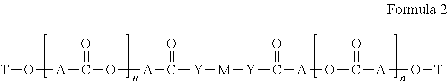
wherein:
each n is independently an integer from 1 to about 100;
each A is independently a branched hydrocarbon chain comprising 4 to 100 carbon atoms;
each T is independently a hydrogen atom or a —C(O)—R wherein each R is an alkyl chain comprising 1 to 30 carbon atoms;
each Y is independently a linking group selected from the group of oxygen and NR₂, wherein each R₂ is independently selected from the group of hydrogen, or a C₁-C₈ alkyl; and
M is a polyalkylene glycol group;
c) a branched polyester having Formula 3 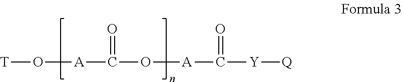
wherein:
the index n is an integer from 1 to about 100;
T is a hydrogen or —C(O)—R₁ where in R₁ is an alkyl chain comprising from 7 to 21 carbon atoms;
each A is independently a branched hydrocarbon chain comprising from 4 to 40 carbon atoms;
Y is selected from the group of oxygen and NR₂, wherein each R₂ is independently selected from the group of hydrogen, or a C₁-C₈ alkyl;
Q is selected from the group of:
i) —B,
ii) —Z—X—Z—W, and
iii) —V—U—Z—X—Z—W;
wherein
B is a substituted C₁-C₂₄ alkyl group;
each Z is independently a substituted or unsubstituted divalent C₂-C₄₀ alkylene radical;
X is polysiloxane moiety;
W is selected from the group of —OR₄, 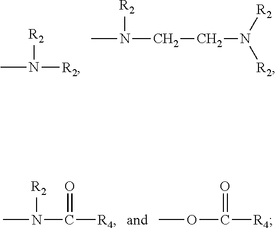
each R₂ is independently selected from the group of hydrogen or a C₁-C₈ alkyl;
R₄ is selected from a hydrogen atom, a C₁-C₂₄ alkyl group or a substituted C₁-C₂₄ alkyl group;
V is a C₁-C₂₄ divalent alkylene radical or a substituted C₁-C₂₄ divalent alkylene;
U is —C(O)O— or —C(O)NH—; and
d) a branched polyester having Formula 4 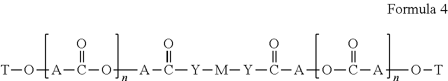
wherein:
each index n is independently an integer from 1 to about 100;
T is a hydrogen atom or —C(O)—R₁ where in R₁ is an alkyl chain comprising from 7 to 21 carbon atoms;
each A is independently a branched hydrocarbon chain comprising from 4 to 40 carbon atoms;
each Y is independently selected from the group of oxygen and NR₂, wherein each R₂ is independently selected from the group of hydrogen or a C₁-C₈ alkyl;
M is selected from the group of:
i) a C₁-C₂₄ divalent linear or branched alkylene radical;
ii) —Z—X—Z—, and
iii) -(D-U—Z—X—Z—U)ₘ-D-
wherein:
m is an integer from 1 to about 10;
each Z is independently a substituted or unsubstituted divalent C₂-C₄₀ alkylene radical;
X is polysiloxane moiety;
U is —C(O)O— or —C(O)NH—; and
each D is independently a C₁-C₂₄ divalent linear or branched alkylene radical;
e) and mixtures thereof.

3. The composition according to claim 1, wherein said first hydrophobic conditioning compound comprises silicone.

4. The composition according to claim 1, wherein said plurality of particles further comprise a second hydrophobic conditioning compound having a weight average molecular weight greater than 1000 Da.

5. The composition according to claim 4, wherein said first hydrophobic conditioning compound comprises a branched polyester selected from the group of:
a) a branched polyester having Formula 1 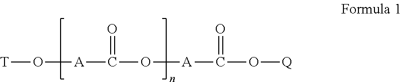
wherein:
each A is independently a branched hydrocarbon chain comprising 4 to 100 carbon atoms;
Q is selected from an alkyl chain comprising 1 to 30 carbon atoms and a hydrogen atom;
T is a hydrogen atom or a —C(O)—R wherein each R is an alkyl chain comprising 1 to 30 carbon atoms; and
n is an integer from 1 to about 100;
b) a branched polyester having Formula 2 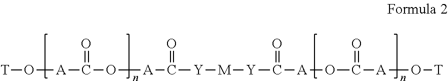
wherein:
each n is independently an integer from 1 to about 100;
each A is independently a branched hydrocarbon chain comprising 4 to 100 carbon atoms;
each T is independently a hydrogen atom or a —C(O)—R wherein each R is an alkyl chain comprising 1 to 30 carbon atoms;
each Y is independently a linking group selected from the group of oxygen and NR₂, wherein each R₂ is independently selected from the group of hydrogen, or a C₁-C₈ alkyl; and
M is a polyalkylene glycol group;
c) a branched polyester having Formula 3 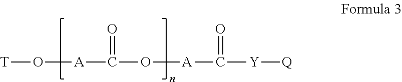
wherein:
the index n is an integer from 1 to about 100;
is a hydrogen or —C(O)—R₁ where in R₁ is an alkyl chain comprising from 7 to 21 carbon atoms;
each A is independently a branched hydrocarbon chain comprising from 4 to 40 carbon atoms;
Y is selected from the group of oxygen and NR₂, wherein each R₂ is independently selected from the group of hydrogen, or a C₁-C₈ alkyl;
Q is selected from the group of:
i) —B,
ii) Z—X—Z—W, and
iii) —V—U—Z—X—Z—W
wherein
B is a substituted C₁-C₂₄ alkyl group;
each Z is independently a substituted or unsubstituted divalent C₂-C₄₀ alkylene radical;
X is polysiloxane moiety;
W is selected from the group of —OR₄, 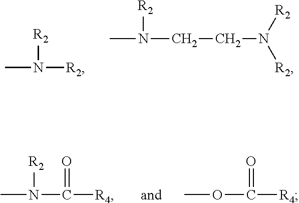
each R₂ is independently selected from the group of hydrogen or a C₁-C₈ alkyl;
R₄ is selected from a hydrogen atom, a C₁-C₂₄ alkyl group or a substituted C₁-C₂₄ alkyl group;
V is a C₁-C₂₄ divalent alkylene radical or a substituted C₁-C₂₄ divalent alkylene;
U is —C(O)O— or —C(O)NH—; and
d) a branched polyester having Formula 4 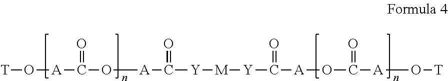
wherein:
each index n is independently an integer from 1 to about 100;
T is a hydrogen atom or —C(O)—R₁ where in R₁ is an alkyl chain comprising from 7 to 21 carbon atoms;
each A is independently a branched hydrocarbon chain comprising from 4 to 40 carbon atoms;
each Y is independently selected from the group of oxygen and NR₂, wherein each R₂ is independently selected from the group of hydrogen or a C₁-C₈ alkyl;
M is selected from the group of:
i) a C₁-C₂₄ divalent linear or branched alkylene radical,
ii) —Z—X—Z—, and
iii) -(D-U—Z—X—Z—U)ₘ-D-
wherein:
m is an integer from 1 to about 10;
each Z is independently a substituted or unsubstituted divalent C₂-C₄o alkylene radical;
X is polysiloxane moiety;
U is —C(O)O— or —C(O)NH—; and
each D is independently a C₁-C₂₄ divalent linear or branched alkylene radical;
e) and mixtures thereof.

6. The composition according to claim 5, wherein said second hydrophobic conditioning compound comprises silicone.

7. The composition according to claim 6, wherein said plurality of particles comprises individual particles that comprise at least one of said first hydrophobic conditioning compound, said second hydrophobic conditioning compound, and said deposition aid; and
wherein said individual particles differ from one another in weight fraction of at least one of said first hydrophobic conditioning compound, said second hydrophobic conditioning compound, and said deposition aid.

8. The composition according to claim 6, wherein individual particles of said plurality of particles comprise said water soluble carrier, said first hydrophobic conditioning compound, said second hydrophobic conditioning compound, said deposition aid, and said salt.

9. The composition according to claim 6, wherein said first hydrophobic conditioning compound is dispersed in said water soluble carrier.

10. The composition according to claim 6, wherein said second hydrophobic conditioning compound is dispersed in said water soluble carrier.

11. The composition according to claim 6, wherein for said Formula 1:
each A is independently a branched hydrocarbon chain comprising from 4 to 40 carbon atoms;
Q is selected from an alkyl chain comprising 1 to 30 carbon atoms and a hydrogen atom;
T is a hydrogen atom or a —C(O)—R wherein each R is an alkyl chain comprising from 7 to 21 carbon atoms; and
n is an integer from 4 to 40;
wherein for said Formula 2:
n is an integer from 4 to 40;
each A is independently a branched hydrocarbon chain comprising from 4 to 40 carbon atoms;
each T is independently a hydrogen atom or a —C(O)—R wherein each R is an alkyl chain comprising from 7 to 21 carbon atoms;
each Y is independently a linking group selected from the group of oxygen and NR₂, wherein each R₂ is independently selected from the group of hydrogen, or a C₁-C₈ alkyl;
M is a polyalkylene glycol group having a structure of 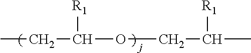
wherein:
each R₁ is selected from hydrogen, methyl and ethyl; and
j is an integer from 0 to about 400.

12. The composition according to claim 6, wherein said branched polyester polymer having Formula 1 and said branched polyester having Formula 2 each have a weight average molecular weight of from about 500 Da to about 100000 Da.

13. The composition according to claim 6, wherein each A of said branched polyester polymers is independently a branched hydrocarbon having the structure 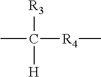
wherein each R₃ is a monovalent alkyl or substituted alkyl group and R₄ is an unsaturated or saturated divalent alkylene radical comprising from 1 to about 24 carbon atoms.

14. The composition according to claim 6, wherein each A of said branched polyester polymers has the structure:

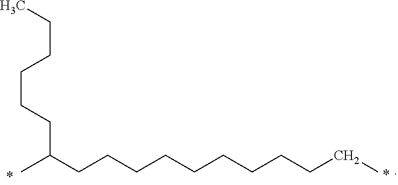 [SMILES: CCCCCCCCCCCC(C)CCCCCC]

15. The composition according to claim 6, wherein the branched polyester polymer has an iodine value from about 0 to about 90.

16. The composition according to claim 6, wherein said salt is selected from the group of magnesium sulfate, ammonium nitrate, ammonium acetate, magnesium acetate tetrahydrate, ammonium sulfate, sodium acetate, zinc sulfate monohydrate, magnesium sulfate heptahydrate, sodium acetate trihydrate, calcium sulfate, calcium sulfate dihydrate, magnesium nitrate hexahydrate, magnesium acetate tetrahydrate, and sodium sulfate decahydrate, calcium citrate tetrahydrate, and combinations thereof.

17. The composition according to claim 6, wherein said water soluble carrier is selected from the group of polyethylene glycol, polypropylene glycol polyoxoalkylene, polyethylene glycol fatty acid ester, polyethylene glycol ether, nonionic starch, and combinations thereof.

18. The composition according to claim 6, wherein said water soluble carrier is polyethylene glycol having a weight average molecular weight from about 3500 Da to about 15000 Da.

19. A process for treating an article of clothing comprising the steps of:
providing an article of clothing in a washing machine; and
contacting said article of clothing during a wash sub-cycle of said washing machine with a composition according to claim 6.

20. The composition according to claim 1,
wherein said plurality of particles comprises from about 25% to about 81% by weight said water soluble carrier; and wherein said plurality of particles comprises from about 8% to about 25% by weight said nonhalide salt.
